(19) United States
(12) Patent Application Publication
(10) Pub. No.: US 2026/0105716 A1
(43) Pub. Date: Apr. 16, 2026

(54) SYSTEMS AND METHODS OF ENABLING REGION OF INTEREST PROCESSING BY A TRAINED MODEL AT INFERENCE-TIME

(71) Applicant: QUALCOMM Incorporated, San Diego, CA (US)

(72) Inventors: Mohit LAMBA, New Delhi (IN); Srenivas VARADARAJAN, Bangalore (IN); Ajit Deepak GUPTE, Bangalore (IN); Titash RAKSHIT, Austin, TX (US)

(21) Appl. No.: 18/916,373

(22) Filed: Oct. 15, 2024

(51) Int. Cl. G06V 10/25; G06T 3/40; G06T 7/11; G06V 10/44

(52) U.S. Cl. CPC G06V 10/25; G06T 3/40; G06T 7/11; G06V 10/44

(57) ABSTRACT

A device includes a memory configured to store model data associated with a trained multimodal model and one or more processors coupled to the memory. The one or more processors are configured to obtain image data representing an image and to obtain data representing a region of interest (ROI) within the image. The one or more processors are also configured to determine boundaries of the ROI within the image based on the data and to generate model input data based on the image data and the data. The one or more processors are also configured to selectively modify the model input data based on the boundaries and to provide the model input data as input to the trained multimodal model to generate a response output.

### I. FIELD

The present disclosure is generally related to image processing.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

These devices may leverage machine learning (ML) models and artificial intelligence (AI) models to enable a wide variety of functionality. For example, language models can be trained on a wide corpus of information to answer questions from a user, such as how to prepare a meal, whether a particular store sells a particular product, or other questions. Additionally, multimodal models, such as large multimodal models (LMMs), combine visual scene and image processing with the functionality of language models to enhance AI systems' ability to understand a visual scene and interactions with human users. For example, a user may view image(s), video, or an extended reality display and ask a question about an object in a visual scene, and a multimodal model may provide a response to the question. Although LLMs and other models are trained to provide answers to a wide variety of questions, the LLMs may struggle to answer more specific or detailed questions related to visual scenes. To improve the capability of a current LLM to correctly answer questions about a visual scene, an LMM can be fine-tuned on particular datasets to learn additional grounding-related tokens, such as datasets that include common objects for a particular use-case of the LMM. However, fine-tuning the LMM based on a particular dataset can result in overfitting to the data, which can degrade the ability of the LMM to correctly answer more general questions. Additionally, baseline training for the LMM may use substantial computer resources that are not readily available after the LMM is initially trained and deployed, making fine-tuning the LMM a cost-prohibitive and infeasible option.

### III. Summary

According to one implementation of the present disclosure, a device includes a memory configured to store model data associated with a trained multimodal model. The device also includes one or more processors coupled to the memory. The one or more processors are configured to obtain image data representing an image. The one or more processors are also configured to obtain data representing a region of interest (ROI) within the image. The one or more processors are also configured to determine boundaries of the ROI within the image based on the data. The one or more processors are also configured to generate model input data based on the image data and the data. The one or more processors are also configured to selectively modify the model input data based on the boundaries. The one or more processors are also configured to provide the model input data as input to the trained multimodal model to generate a response output.

According to another implementation of the present disclosure, a method includes obtaining, by one or more processors, image data representing an image. The method also includes obtaining, by the one or more processors, data representing a region of interest (ROI) within the image. The method also includes determining, by the one or more processors, boundaries of the ROI within the image based on the data. The method also includes generating, by the one or more processors, model input data based on the image data and the data. The method also includes selectively modifying, by the one or more processors, the model input data based on the boundaries. The method also includes providing, by the one or more processors, the model input data as input to a trained multimodal model to generate a response output.

According to another implementation of the present disclosure, a non-transitory computer-readable medium stores instructions that, when executed by one or more processors, cause the one or more processors to obtain image data representing an image. The instructions also cause the one or more processors to obtain data representing a region of interest (ROI) within the image. The instructions also cause the one or more processors to determine boundaries of the ROI within the image based on the data. The instructions also cause the one or more processors to generate model input data based on the image data and the data. The instructions also cause the one or more processors to selectively modify the model input data based on the boundaries. The instructions also cause the one or more processors to provide the model input data as input to a trained multimodal model to generate a response output.

According to another implementation of the present disclosure, an apparatus includes means for obtaining image data representing an image. The apparatus also includes means for obtaining data representing a region of interest (ROI) within the image. The apparatus also includes means for determining boundaries of the ROI within the image based on the data. The apparatus also includes means for generating model input data based on the image data and the data. The apparatus also includes means for selectively modifying the model input data based on the boundaries. The apparatus also includes means for providing the model input data as input to a trained multimodal model to generate a response output.

Other aspects, advantages, and features of the present disclosure will become apparent after review of the entire application, including the following sections: Brief Description of the Drawings, Detailed Description, and the Claims.

### IV. Brief Description of the Drawings

FIG. 1 is a block diagram of an example of a system operable to enable region of interest (ROI) processing by a trained model at inference-time, in accordance with one or more aspects of the present disclosure.

FIG. 2 is a block diagram of an example of components of a device operable to enable ROI processing by a trained model at inference-time, in accordance with one or more aspects of the present disclosure.

FIG. 3 is a block diagram of an example of a trained multimodal model that supports inference-time ROI processing, in accordance with one or more aspects of the present disclosure.

FIG. 4 is a diagram of an example of operations that enable ROI processing by a trained model at inference-time, in accordance with some aspects of the present disclosure.

FIG. 5 is a diagram of an example of additional operations that enable ROI processing by a trained model at inference-time, in accordance with some aspects of the present disclosure.

FIG. 6 is a diagram of an example of additional operations that enable ROI processing by a trained model at inference-time, in accordance with some aspects of the present disclosure.

FIG. 7 is a diagram of an example of a method of ROI enhancement to enable ROI processing by a trained model at inference-time, in accordance with some aspects of the present disclosure.

FIG. 8 is a diagram of an example of an integrated circuit operable to enable ROI processing by a trained model at inference-time, in accordance with some examples of the present disclosure.

FIG. 9 is a diagram of a mobile device operable to enable ROI processing by a trained model at inference-time, in accordance with some examples of the present disclosure.

FIG. 10 is a diagram of a headset, such as a virtual reality, mixed reality, or augmented reality headset, operable to enable ROI processing by a trained model at inference-time, in accordance with some examples of the present disclosure.

FIG. 11 is a diagram of a wearable electronic device operable to enable ROI processing by a trained model at inference-time, in accordance with some examples of the present disclosure.

FIG. 12 is a diagram of a voice-controlled speaker system operable to enable ROI processing by a trained model at inference-time, in accordance with some examples of the present disclosure.

FIG. 13 is a diagram of a camera operable to enable ROI processing by a trained model at inference-time, in accordance with some examples of the present disclosure.

FIG. 14 is a diagram of a vehicle operable to enable ROI processing by a trained model at inference-time, in accordance with some examples of the present disclosure.

FIG. 15 is a diagram of an example of a method of enabling ROI processing by a trained model at inference-time, in accordance with some aspects of the present disclosure.

FIG. 16 is a block diagram of an illustrative example of a device that is operable to enable ROI processing by a trained model at inference-time, in accordance with one or more aspects of the present disclosure.

### V. DETAILED DESCRIPTION

The present disclosure provides systems, apparatus, methods, and computer-readable media for enabling region of interest (ROI) processing by a trained model at inference-time. Conventional trained models, such as large multimodal models (LMMs) are typically trained to receive image(s) and a question as input and to generate a response to the question based on information in the image(s) and one or more knowledge base(s) that the model was trained on. Such models do not support an input that indicates a ROI (e.g., a portion or subsection) within the image(s) in which the user is focused on, which could improve the correctness or relevance of the response generated by the model without losing generality of the model in situations in which a ROI is not provided. Additionally, fine-tuning or retraining the model to receive ROI-based input may be cost-prohibitive or otherwise infeasible.

Aspects disclosed herein enable a model, such as a multimodal model (e.g., an LMM), that was not initially trained or fine-tuned to focus on a particular region to support ROI-based processing at inference-time without re-training or fine-tuning the model. In some embodiments, the techniques described herein support ROI-aware tile-boundary adjustment to enable trained models with tile-processing capabilities for images to process a ROI as a cohesive unit instead of potentially breaking apart the ROI across multiple tiles. In some embodiments, the techniques described herein provide encoding-agnostic ROI insertion and scaling that does not specifically encode bounding box coordinates of a ROI and instead works with multiple types of vision encoders such that encoded and mapped ROI features can be seamlessly appended to other visual tokens in the input format of existing models (e.g., existing LMMs). These features may be enhanced using techniques that reduce or minimize resampling artifacts and information loss while encoding to arbitrarily-sized ROI regions supported by existing image encoders. Additionally, or alternatively, the techniques described herein may amplify cross-attention between the ROI-based inputs and the question (e.g., the query) to be answered by the model, as compared to other inputs, which can improve the accuracy or relevance of the response generated by the model.

In some aspects disclosed herein, a device implements a trained multimodal model, or other type of model, that is not pretrained or fine-tuned to focus on any particular region of an image. The device obtains image data representing an image in addition to data representing an ROI within the image. For example, the user may select boundaries of a ROI within the image, such as by circling a region of the image on the touchscreen, or the device may determine the boundaries of the ROI based on detected measurements from one or more sensors, such as using a gaze tracking system, capturing orientation data associated with the user, or the like. Additionally, the device may obtain data representing a query associated with the image. For example, a user of the device may provide the query by using a touchscreen or other user interface, speaking the query, or providing one or more gestures that represent the query, and the device may obtain image data from a camera or other image sensor, a memory, or another image source. The device generates model input based on the image data and the query, such as by generating text data based on the query and by dividing the image into multiple tiles (e.g., patches) that are to be encoded and mapped using an image encoder. Prior to providing the model input data to the multimodal model to generate a response output associated with the query, the device selectively modifies the model input data based on the boundaries to inject ROI-based input data into the trained multimodal model in a format supported by the trained multimodal model without retraining the multimodal model.

According to some aspects, the model input data may be modified as part of a ROI-aware tile-boundary adjustment. To illustrate, the device may determine whether the ROI extends across multiple tiles based on the boundaries and, if the ROI extends across multiple tiles, at least some of the tile boundaries may be adjusted. For example, if an image is divided into four tiles and the ROI extends from the second tile into a portion of the fourth tile, the size and/or boundary of the second tile may be increased such that, after the modification, the ROI is entirely within the second tile. Additionally, the size and/or boundary of the fourth tile may be decreased such that, after the modification, the ROI is not included within the fourth tile (e.g., the second tile includes an entirety of the ROI). In this manner, tile sizes and boundaries may be adjusted to cause the ROI to be contained within a single tile, which may reduce the likelihood of inaccurate responses caused by information loss from dividing the ROI.

According to some aspects, the model input data may be modified as part of an encoding-agnostic ROI insertion and scaling process. To illustrate, in addition to encoding and mapping the tiles of the image data to a format that can be combined with tokens that are derived from the query, an additional ROI patch can be generated and encoded and mapped to the same format for use by the multimodal model. For example, instead of merely providing the boundaries of the ROI as input to the multimodal model, which is not trained to accept such an input, the device may generate an additional patch (e.g., tile) from the image that contains the ROI and that satisfies the same formatting or size criterion(s) associated with the tiles of the image. In some aspects, generating the ROI patch may include scaling the ROI to reduce or minimize resampling artifacts and information loss during the encoding and mapping process. For example, if the boundaries of the ROI satisfy a first threshold, a patch that includes the ROI may be extracted from the image and upscaled using upscaling operations that preserve the aspect ratio of the ROI. As another example, if the boundaries of the ROI satisfy a second threshold, a patch that includes the ROI may be extracted from the image and no scaling operations are performed. As another example, if the boundaries of the ROI satisfy a third threshold, a patch that includes the ROI may be extracted from the image and downscaled using downscaling operations that preserve the aspect ratio of the ROI. In this manner, the ROI may be extracted from the image and scaled and/or enhanced while satisfying input format criteria associated with the multimodal model.

According to some aspects, the model input data may be modified as part of a process to amplify cross-attention between the ROI-based inputs and the question (e.g., the query) to be answered by the multimodal model. As part of this process, one or more hyperparameter values of the trained multimodal model that are indicative of a relative weighting of features associated with the ROI relative to features of the image for areas outside the ROI may be adjusted. To illustrate, a regular self-attention mechanism of a language model tends to provide attention to all input tokens equally based on a weighted average of the value tensors and weights that are given by a softmax function. To favor the inputs related to the ROI, the attention can be unequally distributed. For example, a new attention tensor can be added to the self-attention mechanism, with the new attention tensor weighting input tokens associated with the ROI-based inputs higher than other inputs. Adjusting the hyperparameters (e.g., the attention tensor) of the trained multimodal modal can cause increased focus on the ROI without retraining the multimodal model or fine-tuning the multimodal model to particular locations or types of regions in images.

Particular implementations of the subject matter described in this disclosure can be implemented to realize one or more of the following potential advantages. In some aspects, a technical benefit provided by the disclosed techniques is improved accuracy and utility of responses generated by a trained model by enabling inference-time ROI-processing by the model without re-training or initial fine-tuning. Because the disclosed techniques can enable a pretrained model to support ROI-based focus during inference, the improved accuracy and utility of responses can be achieved without the costs associated with re-training the model or with initially fine-tuning the model to focus on particular locations or types of regions in images. For example, supporting inference-time ROI-focus without retraining enables systems that lack the significant computer resources associated with ML and AI model training to provide the improved responses without significantly increasing cost, device complexity, or training time at other devices. Additionally, because the trained model is not fine-tuned to focus on specific locations or types of regions in images, the trained model is more flexible for a variety of situations because there is no associated loss of generality from fine-tuning while also providing the adaptability of focusing on selected ROIs.

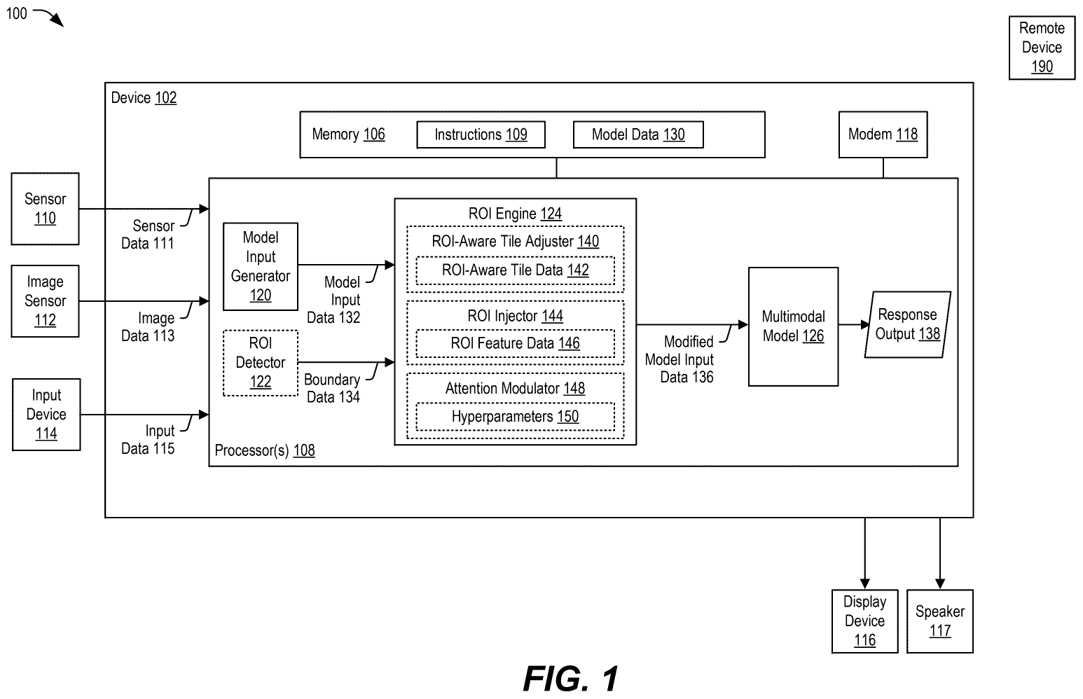

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system 100 operable to enable ROI processing by a trained model at inference-time, in accordance with one or more aspects of the present disclosure. The system 100 includes a device 102 that is operable to enable ROI processing by a multimodal model 126 (e.g., a trained model) at inference-time. The system 100 optionally includes a remote device 190 such that, in some examples, the system 100 includes the remote device 190 and in other examples, the remote device 190 is not included in the system 100. Although described as a remote device, in some other embodiments, the remote device 190 may instead be geographically co-located with the device 102.

The device 102 includes a memory 106, one or more processors 108 (collectively referred to herein as the “processor 108”), and a modem 118. The memory 106 may include one or more memories, such as a single memory or multiple different memories (of the same type or of different types). The memory 106 is configured to store instructions 109 and model data 130. The model data 130 includes or indicates one or more parameters, one or more hyperparameters, configuration data, other data, or a combination thereof, associated with a trained model that is implemented by the device 102, such as a multimodal model 126. In some examples, the memory 106 further includes or stores the instructions 109 that, when executed by the processor 108, cause the processor 108 to perform one or more operations described herein. In some examples, the memory 106 stores other information or data, such as thresholds, criterion(s), image data, video data, augmented reality data, applications, or a combination thereof.

The processor 108 includes a model input generator 120, an ROI detector 122, an ROI engine 124, and the multimodal model 126. Each of the model input generator 120, the ROI detector 122, the ROI engine 124, the multimodal model 126, or a portion thereof, may be implemented by the processor 108 executing instructions (e.g., software), dedicated hardware (e.g., circuitry), a combination thereof. In some aspects, the processor 108 is coupled to one or more image sources (not shown). In some embodiments, the image source(s) provide image data to the processor 108, and can be external to or internal to the device 102. For example, the image source(s) can include input files (e.g., media data) stored in the memory 106 of the device 102, from a game engine, or from an extended reality (XR) engine (e.g., a virtual reality (VR) engine, an augmented reality (AR) engine, or a mixed reality (MR) engine). As another example, the image source(s) can include the image sensor 112 and the processor 108 can receive image data 113 from the image sensor 112. As another example, the image source(s) can include the remote device 190, and image data received from the remote device 190 can be provided to the processor 108 by the modem 118.

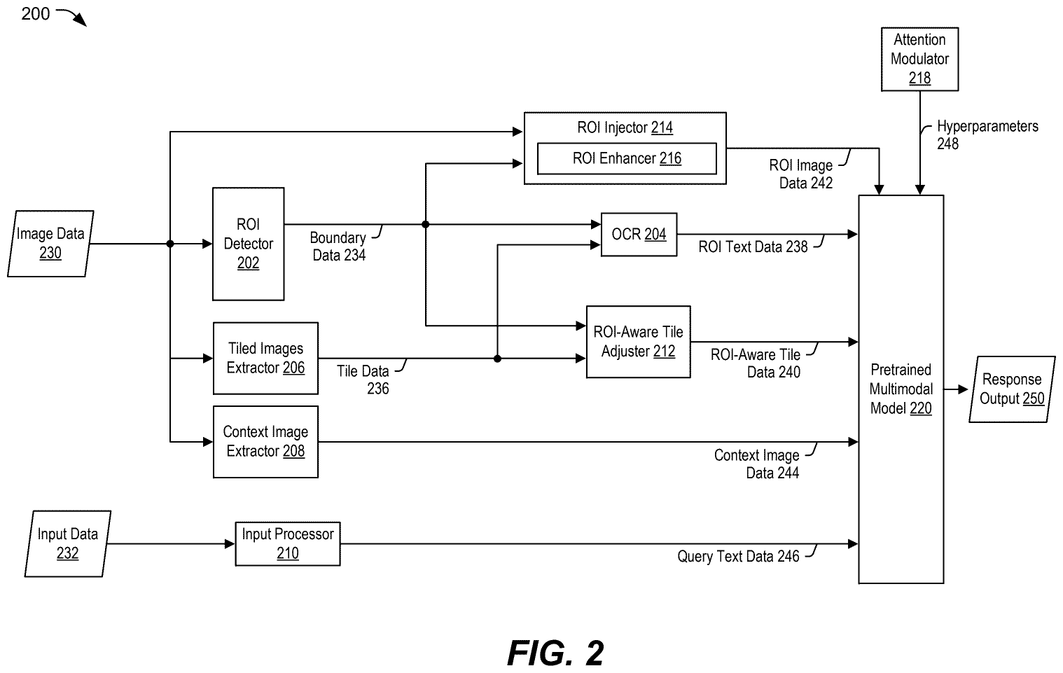

The model input generator 120 is configured to generate model input data 132 that is to be provided as input to the multimodal model 126, after selective modification by the ROI engine 124. For example, the model input generator 120 may be configured to process image data and data that represents a query (e.g., a user question or a question generated by an application or received from another device) to be answered by the multimodal model 126 to generate image features and text features, respectively, and the model input data 132 may be based on the image features and the text features. For example, the model input data 132 may be based on the image data 113 (or an image from another image source) and a query (e.g., a question) represented by input data 115 from an input device 114 (or a question from another source, such as an application executed by the processor 108 or received from the remote device 190). In some aspects, the model input generator 120 is configured to divide the image into a set of tiles that each have a corresponding size that is based on a size criterion associated with the multimodal model 126. For example, the multimodal model 126 may be configured to receive images that have a particular size or aspect ratio, and the model input generator 120 may scale and divide (e.g., tile) the image represented by the image data 113 into multiple tiles (e.g., image portions or sub-images) that each have the same particular size or aspect ratio associated with the multimodal model 126 (e.g., an image encoding and mapping model). In other implementations, the tiling is omitted, and the model input data 132 represents the image as a whole and the query. Additionally, or alternatively, the model input generator 120 may be configured to scale the image as a context image according to the size or aspect ratio criterion. In some other embodiments, the query is omitted (e.g., for a multimodal model that is trained for a different purpose than answering text-based questions). Additional examples of operations performed by the model input generator 120 are further described herein with reference to FIG. 2.

The ROI detector 122 is configured to determine boundaries of a ROI within an image indicated by image data received from the image source, such as image data 113 from an image sensor 112. For example, the ROI detector 122 may determine a bounding box (or other boundary shape) of a ROI within an image, and the ROI detector 122 may output coordinates of one or more pixels of the boundary, dimensions (e.g., height, width), or other boundary characteristics as boundary data 134. As an illustrative example, the boundary data 134 may represent or indicate an upper left corner of the boundaries of an ROI within an image, a height of the boundaries, and a width of the boundaries. In some aspects, the ROI detector 122 is configured to determine the boundaries (e.g., the boundary data 134) based on sensor data 111 from a sensor 110. To illustrate, the sensor 110 may be configured to detect a characteristic that indicates boundaries of a ROI, and the sensor data 111 may represent the detected characteristic, which is provided to the ROI detector 122 for determining the boundary data 134. The characteristic may include a gaze of a user or an orientation of the user's head or the device 102 that represents the boundaries, or other types of conditions, as further described herein. As another example, the sensor 110 may include one or more microphones that are configured to generate audio data (e.g., the sensor data 111) that represents user speech that includes a description of the boundaries. In some embodiments, the ROI detector 122 is configured to determine the ROI based on additional information that may be received in conjunction with the image data 113, such as when the image data 113 represents a pair of stereo images, when the image data 113 represents a sequence of images to enable optical flow techniques, or when additional sensor data is provided from a sensor system such as lidar or structured light.

In embodiments that do not include the ROI detector 122, the boundary data 134 may be determined based on input data 115 from an input device 114. For example, the input device 114 may include a touchscreen, and a user may mark the boundaries of the ROI in the image on the touchscreen. In this example, the input data 115 may represent or indicate the boundaries of the ROI, and the boundary data 134 may be generated based on the input data 115. As another example, the input device 114 may include a keypad or a touchscreen, and the input device 114 may be configured to generate text data (e.g., the input data 115) based on user input that represents or indicates the boundaries of the ROI. In some other embodiments that include the ROI detector 122, the ROI detector 122 may be configured to supplement boundaries indicated by the input data 115 with additional boundary determinations based on the sensor data 111.

The ROI detector 122 is optional (and is illustrated with dotted lines in FIG. 1). Thus, in some embodiments, the processor 108 includes the ROI detector 122 that is configured to generate the boundary data 134 that is provided to the ROI engine 124. In some other embodiments, the processor 108 does not include the ROI detector 122, and the boundary data 134 is received with, or derived from, other received data such as the input data 115 (e.g., the input data 115 may indicate a user-selected boundary) or the sensor data 111 (e.g., the boundary data 134 may be determined based on the sensor data 111).

The ROI engine 124 is configured to selectively modify the model input data 132 based on the boundary data 134 (e.g., the boundaries of the ROI within the image). For example, the ROI engine 124 may, upon a determination to modify the model input data 132, generate modified model input data 136 by modifying the model input data 132. Modifying the model input data 132 to generate the modified model input data 136 enables the multimodal model 126 to focus on a ROI within an image when answering a question without any additional training or fine-tuning to the multimodal model 126. In some examples, the ROI engine 124 is configured to selectively modify the model input data 132 based on whether the boundaries indicated by the boundary data 134 satisfy one or more thresholds or criteria. To illustrate, the ROI engine 124 may determine whether the boundaries satisfy one or more thresholds or criteria and, based on the determination, either modify the model input data 132 to generate the modified model input data 136 or pass the model input data 132 without modification to the multimodal model 126. For example, if the ROI engine 124 determines that the boundaries satisfy one or more thresholds or criteria, the ROI engine 124 may modify the model input data 132 to generate the modified model input data 136 prior to providing the modified model input data 136 as input to the multimodal model 126 (e.g., the modified model input data 136 is provided based on the boundaries satisfying the one or more thresholds). Alternatively, if the ROI engine 124 determines that the boundaries fail satisfy the one or more thresholds or criteria, the ROI engine 124 may provide the model input data 132, without modification, as input to the multimodal model 126 (e.g., the model input data 132 is provided based on the boundaries failing to satisfy the one or more thresholds). Examples of determining whether the boundaries satisfy the one or more thresholds or criteria are further described below.

The ROI engine 124 may generate the modified model input data 136 by altering (e.g., adjusting or changing values of) portion(s) of the model input data 132, adding additional data related to the ROI to the model input data 132, altering or adding one or more hyperparameters associated with the multimodal model 126, or a combination thereof. As an example, the ROI engine 124 may alter boundaries of one or more tiles generated by the model input generator 120 to generate the modified model input data 136 that includes ROI-aware tiles. Additionally, or alternatively, the ROI engine 124 may add an ROI patch (e.g., an ROI tile or a sub-image that includes the ROI), which may be scaled and/or enhanced, to the model input data 132 to generate the modified model input data 136. Additionally, or alternatively, the ROI engine 124 may add or adjust one or more hyperparameters associated with the multimodal model 126 to increase weights associated with tokens derived from ROI-related inputs.

In some aspects, the ROI engine 124 includes an ROI-aware tile adjuster 140, an ROI injector 144, an attention modulator 148, or a combination thereof. The ROI-aware tile adjuster 140, the ROI injector 144, and the attention modulator 148 are optional (and are illustrated with dotted lines in FIG. 1). Thus, in some embodiments, the ROI engine 124 includes the ROI-aware tile adjuster 140 and not the ROI injector 144 or the attention modulator 148. In some other embodiments, the ROI engine 124 includes the ROI injector 144 and not the ROI-aware tile adjuster 140 or the attention modulator 148. In some other embodiments, the ROI engine 124 includes the ROI-aware tile adjuster 140 and the ROI injector 144 and not the attention modulator 148. In some other embodiments, the ROI engine 124 includes the ROI injector 144 and the attention modulator 148 and not the ROI-aware tile adjuster 140. In some other embodiments, the ROI engine 124 includes the ROI-aware tile adjuster 140, the ROI injector 144, and the attention modulator 148.

The ROI-aware tile adjuster 140 is configured to determine, based on the boundaries indicated by the boundary data 134, whether the ROI extends across multiple tiles of the set of tiles included in the model input data 132 and to selectively modify one or more boundaries of the tiles based on the determination to generate ROI-aware tile data 142. For example, if the ROI-aware tile adjuster 140 determines that the tiles are generated such that the ROI in the image (indicated by the boundary data 134) extends across the multiple tiles (e.g., at least a portion of the ROI is included within multiple tiles), the ROI-aware tile adjuster 140 modifies the boundaries of the tiles that include the ROI so that the ROI is only included in a single tile, and the modified tile boundaries are represented by the ROI-aware tile data 142. In examples in which the ROI-aware tile adjuster 140 adjusts one or more tile boundaries, the modified model input data 136 includes the ROI-aware tile data 142 (e.g., replacing the portions of the model input data 132 that correspond to the one or more adjusted tile boundaries). Alternatively, if the ROI-aware tile adjuster 140 determines that the ROI is included in a single tile of the tiles indicated by the model input data 132, the ROI-aware tile adjuster 140 does not modify the tile boundaries to generate the ROI-aware tile data 142 and instead maintains the tile boundaries in the model input data 132.

As an illustrative example, the model input data 132 may indicate four tiles of an image represented by the image data 113: an upper-left tile (e.g., quarter of the image), an upper-right tile, a lower-left tile, and a lower-right tile, and the ROI within the image may extend across the border between the upper-right tile and the lower-right tile, such that a large portion of the ROI is included in the upper-right tile and a small portion of the ROI is included in the lower-right tile. This division of the ROI into different tiles may result in typical models incorrectly answering a question related to the ROI due to tile-by-tile processing that fails to focus on the ROI as a cohesive whole. To prevent this information loss or inaccuracy, the ROI engine 124 may, based on the ROI extending across the multiple tiles, modify a size of a first tile (e.g., the upper-right tile) such that, after modification of the size, the first tile includes an entirety of the ROI. For example, the ROI engine 124 may increase the height of the upper-right tile such that the modified upper-right tile includes the entirety of the ROI.

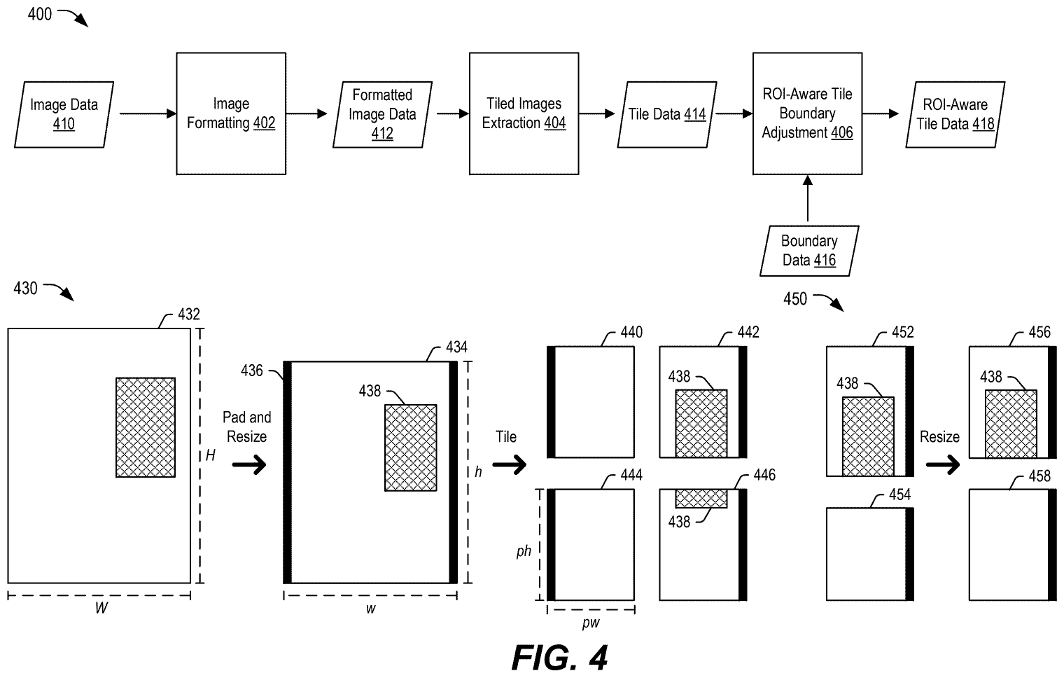

Additionally, for each tile of one or more other tiles included in the multiple tiles indicated by the model input data 132, the ROI engine 124 may modify a size of the tile such that the ROI is not included in the tile. To illustrate, the ROI-aware tile adjuster 140 may decrease the height of a second tile (e.g., the lower-right tile) that also includes a portion of the ROI such that, after modification, the ROI is not included in the second tile. For example, the ROI-aware tile adjuster 140 may decrease the height of the lower-right tile such that there is no overlap between the modified upper-right tile and the modified lower-right tile, which may cause the entirety of the ROI to be included in the modified upper-right tile and no portion of the ROI to be included in the modified lower-right tile. Tiles that do not include the ROI (e.g., the upper-left tile and the lower-left tile) maintain the same boundaries, such that the ROI-aware tile data 142, in this example, represents the upper-left tile, the modified upper-right tile, the lower-left tile, and the modified lower-right tile. The above-described example is illustrative, and in other examples, the model input data 132 may represent fewer than four or more than four tiles, the ROI may extend across more than two tiles, the tile boundaries may be adjusted in a different manner, or a combination thereof. Additional examples and details of ROI-aware tile adjustment are described further herein with reference to FIGS. 2 and 4.

The ROI injector 144 is configured to determine, based on the boundaries represented by the boundary data 134, whether to generate ROI feature data 146 for inclusion in the modified model input data 136 to represent the ROI. Similar to the tile data included in the model input data 132, the ROI feature data 146 includes features derived from an additional patch (e.g., a tile) of the image that includes the ROI and that may be scaled or enhanced by the ROI injector 144. The ROI injector 144 may combine the ROI feature data 146 with the model input data 132 to generate the modified model input data 136 in order to inject input information associated with the ROI into the input to be provided to the multimodal model 126.

In some aspects, the ROI injector 144 is configured to determine whether the boundaries represented by the boundary data 134 satisfy one or more thresholds or criteria and, if the boundaries satisfy the one or more thresholds or criteria, generate the ROI feature data 146 for inclusion in the modified model input data 136. For example, if the boundaries indicate that the ROI has a size that is no greater than a first threshold (e.g., 25% of the size of the image, as a non-limiting example), the ROI injector 144 may identify a patch within the image that includes the ROI, and the ROI injector 144 may generate the ROI feature data 146 based on the patch. The size of the patch may be determined based on a comparison of the size (e.g., the boundaries) of the ROI to other thresholds, and the patch may be scaled (e.g., upscaled or downscaled) using aspect ratio-preserving scaling operation(s) to enhance the ROI based on the comparison. Additional examples and details associated with identifying and extracting a patch that includes an ROI are described further herein with reference to FIGS. 2, 5, and 7.

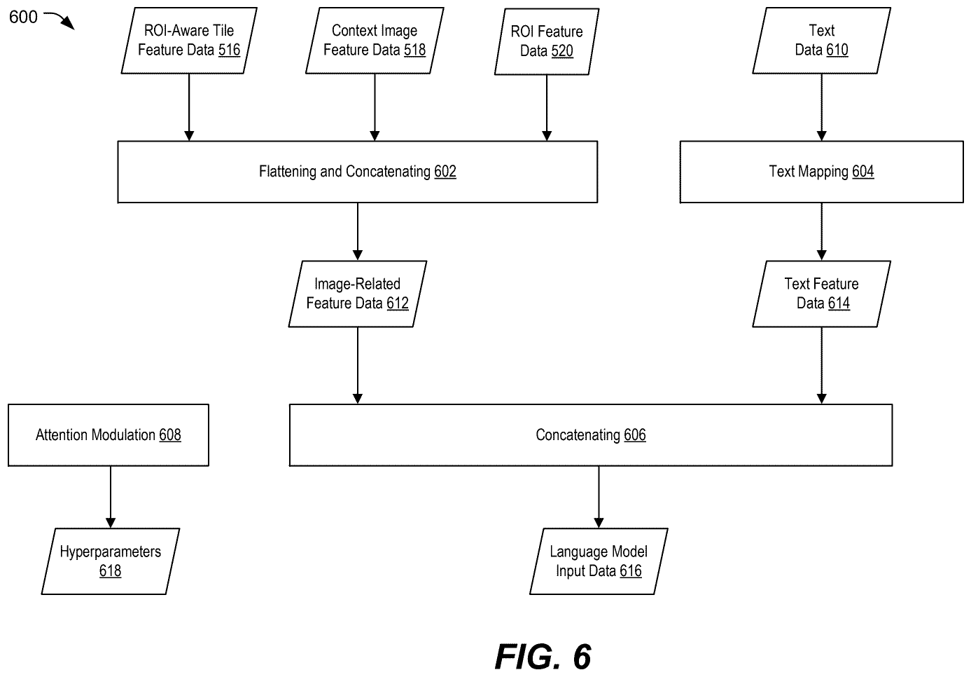

The attention modulator 148 is configured to obtain and selectively adjust one or more hyperparameter values of the multimodal model 126 based on the boundaries represented by the boundary data 134. For example, the attention modulator 148 may obtain (e.g., generate or select) hyperparameters 150 of the multimodal model 126 that are indicative of a weighting of the features associated with the ROI relative to a weighting of features of the image for areas outside the ROI (e.g., the tiles, the image as a whole (e.g., the context image), or both). In some examples, the hyperparameters 150 may include or correspond to an attention tensor of a self-attention mechanism associated with the multimodal model 126, and setting the values to non-zero or non-initial values of the hyperparameters 150 may increase the relative weighting of the ROI-related features to the other image-related features when the hyperparameters 150 are included in the modified model input data 136 (e.g., are provided to the multimodal model 126). Additional details of the attention tensor and the self-attention mechanism are described further herein with reference to FIGS. 2 and 6. In some aspects, the attention modulator 148 is configured to obtain the hyperparameters 150 based on the boundaries of the ROI. For example, if the size of the ROI is small enough that a patch that includes the ROI contains significantly less visual information than the other tiles represented by the model input data 132, the attention modulator 148 may obtain the hyperparameters 150 to increase the focus of the multimodal model 126 on the ROI feature data 146. Additionally, or alternatively, the attention modulator 148 may obtain the hyperparameters 150 regardless of the boundaries and/or size of the ROI in situations in which the ROI injector 144 generates the ROI feature data 146 and includes the ROI feature data 146 in the modified model input data 136.

Each of the ROI-aware tile adjuster 140, the ROI injector 144, and the attention modulator 148 is optional (and is illustrated with dotted lines in FIG. 1) such that, in some embodiments, the processor 108 includes one or more of the ROI-aware tile adjuster 140, the ROI injector 144, and the attention modulator 148 that are configured to generate the ROI-aware tile data 142, the ROI feature data 146, and the hyperparameters 150, respectively. In some other embodiments, the processor 108 does not include one or more of the ROI-aware tile adjuster 140, the ROI injector 144, and the attention modulator 148, and the associated operations are not performed by the ROI engine 124.

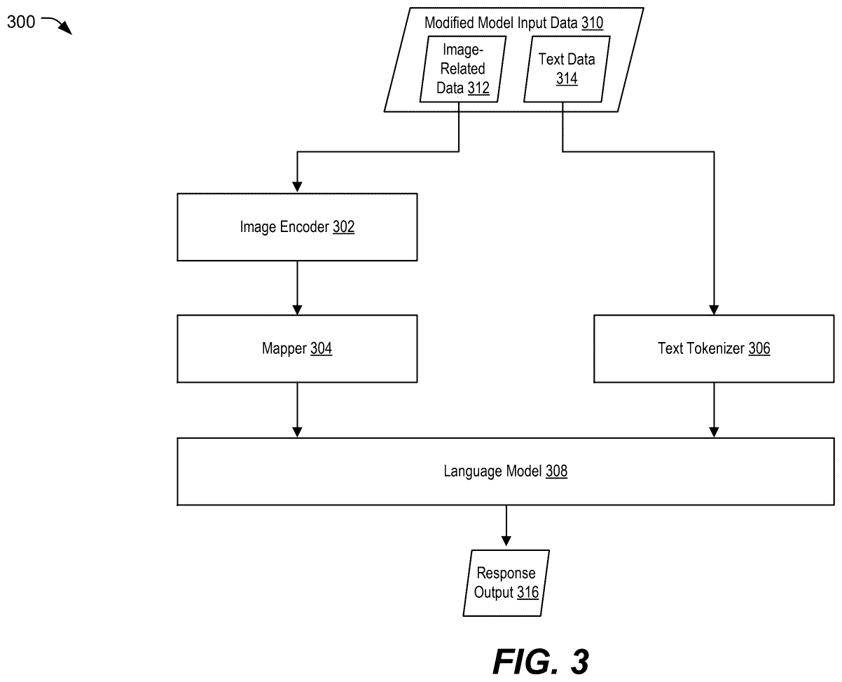

The multimodal model 126 is configured to process data from multiple modalities to generate a response output 138 that represents an answer to a question (e.g., query), such as a question indicated by the input data 115. For example, the multimodal model 126 may be configured to process image data (e.g., still images, video frames, etc.) and text data and be trained to generate the response output 138 based on knowledge from a corpus of documents (or another knowledge base) and input image data to provide the response output 138 that represents the most likely answer to the question. The multimodal model 126 may be pretrained to process image data and text data, and not be pretrained or fine-tuned to process ROI-related input data, such as an off-the-shelf multimodal model (e.g., a large multimodal model (LMM)). In some aspects, the multimodal model 126 includes an image encoding and mapping model, a text encoding model, and a language model, as further described with reference to FIG. 3. In such aspects, the image encoding and mapping model is configured to generate first feature data based on image-related data (e.g., the modified model input data 136 or the model input data 132) and the text encoding model is configured to generate second feature data based on text-related data (e.g., the query data represented by the modified model input data 136 or the model input data 132). The first feature data and the second feature data may be mapped or tokenized to a common token space.

In such aspects, the language model is configured to generate the response output 138 based on the first feature data and the second feature data. For example, the language model may include an off-the-shelf language model, such as a large language model (LLM), that is trained to answer a question indicated by the second feature data based on trained knowledge and image-related data indicated by the first feature data. Additional details of the multimodal model 126 are described further herein with reference to FIGS. 3 and 6. The multimodal model 126 may be trained at the device 102 or may be received after training at another device, such as the remote device 190 (e.g., a remote server that transmits the model data 130 to the device 102). Although embodiments described herein include the multimodal model 126, in other embodiments, the processor 108 may include or have access to a trained text model but not image encoding and mapping models, and the image data 113 may be encoded and mapped to the token space by one or more additional models (e.g., one or more image models at another device, such as the remote device 190) or may be encoded and mapped using other techniques.

The modem 118 is coupled to the processor 108 and is configured to transmit text data or multimedia data (e.g., the response output 138) to a second device, such as the remote device 190 (e.g., a remote server). Additionally, or alternatively, the modem 118 is configured to transmit other data, such as image data, video data, audio data, or a combination thereof, to the remote device 190. In some embodiments, the modem 118 may be configured to receive data from another device, such as the remote device 190 (e.g., a remote server or user device). For example, the data received by the modem 118 may include the image data 113, data representing the query and the ROI (e.g., the sensor data 111, the input data 115, or both), the model data 130, media data (e.g., image data, video data, or audio data), other input(s), or a combination thereof.

The processor 108 is also coupled to a sensor 110, an image sensor 112, an input device 114 (e.g., a microphone, a keyboard or touch screen, etc.), a display device 116, and a speaker 117. The sensor 110 may include one or more orientation sensors, one or more position sensors, one or more inertial sensors (e.g., an inertial measurement unit (IMU)), a gaze detection sensor, one or more microphones or other audio capture devices, or a combination thereof. The sensor 110 is configured to generate sensor data 111 that indicates one or more sensed conditions associated with the device 102, such as an orientation, a position, a velocity, an acceleration, a gaze direction of a user of the device 102, a command associated with the device 102, or a combination thereof. The image sensor 112 may include one or more cameras and may be configured to generate image data 113. The input device 114 is configured to receive an input and provide the input to the processor 108 as input data 115. For example, the input device 114 may include a keyboard, a keypad, a touch screen, or one or more microphones configured to receive the input and provide the input data 115 (e.g., an input signal) to the processor 108. In some examples, the input data 115 includes text data that indicates or represents boundaries of an ROI, a query, or a combination thereof. In some examples, the input data 115 includes audio data that represents user speech that indicates or represents boundaries of an ROI, a query, or a combination thereof.

The display device 116 is coupled to the processor 108 and is configured to output one or more displayable outputs to a user of the device 102. The displayable output(s) may include the image data 113 representing the image, an indication of the ROI of the image, media data based on the image data 113, the response output 138, other visual output(s), or a combination thereof. In some examples, the display device 116 includes a display screen, a monitor or television, a projector, or a combination thereof. The speaker 117 is coupled to the processor 108 and is configured to output one or more audio outputs. For example, the speaker 117 may output audio that corresponds to media data stored at the memory 106 or received from another device, audio that corresponds to media data that includes the image data 113, audio that corresponds to the response output 138, other audio, or a combination thereof.

The sensor 110, the image sensor 112, the input device 114, the display device 116, the speaker 117, or a combination there may be coupled to or integrated within the device 102. Although the device 102 is described as being coupled to or including the sensor 110, the image sensor 112, the input device 114, the display device 116, the speaker 117, and the modem 118, in other implementations the device 102 may not include or be coupled to the sensor 110, the image sensor 112, the input device 114, the display device 116, the speaker 117, the modem 118, or a combination thereof. As such, any of the sensor 110, the image sensor 112, the input device 114, the display device 116, the speaker 117, or the modem 118 may be optional and, in embodiments in which such component(s) are not included in or coupled to the device 102, the corresponding data may be received from, or transmitted to, another device, such as the remote device 190.

During operation of the system 100, the processor 108 obtains input image data and query data that is provided to the model input generator 120 to generate the model input data 132. The input image data may include or correspond to the image data 113 generated by the image sensor 112, image data stored at the memory 106, image data generated by an application executed by the processor 108, image data received from the remote device 190, or a combination thereof. The query data may include or correspond to the input data 115 generated by the input device 114 and may represent a query (e.g., a question) to be answered by the multimodal model 126. As an illustrative example, the image data 113 may represent an image of a table with a plate of food and a bottled beverage, and the input data 115 may represent the question “What is the price of the beverage on the table?” In this example, including ROI-related data as input to the multimodal model 126 may enable the multimodal model 126 to correctly identify that the beverage is a particular brand of soda (e.g., based on image-related data, optical character recognition (OCR) data, etc.) and, based on other knowledge on which the multimodal model 126 was trained, to output a price of the particular brand of soda at a store that is geographically near the user as the response output 138. Although described as being a user-generated question that is indicated by the input data 115, in other embodiments, the query may be generated by the processor 108, such as by an application executed by the processor 108, or received from the remote device 190.

The model input generator 120 generates the model input data 132 based on the image data 113 and the input data 115 (e.g., based on the image and the query). For example, the model input generator 120 may generate image-related input data based on the image data 113 and text-related input data based on the input data 115. To generate the image-related input data, the model input generator 120 may process and divide (e.g., logically allocate portions of) the image represented by the image data 113 into a set of tiles that each have a corresponding size that is based on a size criterion associated with the multimodal model 126 (e.g., an image encoding and mapping model included in the multimodal model 126). As an example, the image may have a height that is approximately twice a height criterion associated with input to the multimodal model 126 and a width that is approximately twice a width criterion associated with input to the multimodal model 126. In this example, the model input generator 120 divides the image into four non-overlapping equal-sized tiles that each have a height and width that satisfy the height and width criteria. It should be understood that the image including non-overlapping equal-sized tiles is provided as an illustrative example, in other examples the image can include two or more overlapping tiles, can include at least one tile that has a different size than another tile, or both. The tiles, or features derived from the tiles, are included in the model input data 132. In some aspects, the model input generator 120 may also generate a context image input based on an entirety of the image. For example, the model input generator 120 may scale the image to satisfy the height and width criteria associated with the multimodal model 126 to generate a context image input that is included in the model input data 132, or that is used to derive features that are included in the model input data 132. In some embodiments, the context image input is a lower definition image than the tiles. To generate the text-related input data, the model input generator 120 may process the input data 115 to generate text data that represents the query, and the text data, or features derived from the text data, is included in the model input data 132. Thus, prior to any modification by the ROI engine 124, the model input data 132 represents the image, a set of tiles generated from the image, and the query.

In addition to obtaining the input image data and the query data, the processor 108 obtains data that indicates a ROI within the image. The ROI may be selected by the user, such as by tracing boundaries of the ROI in the image using a touchscreen (e.g., the input device 114), or determined based on one or more sensed conditions associated with the device 102 or the user. For example, the user may provide user input via the input device 114 that indicates the ROI, and the processor 108 may determine the boundary data 134 that indicates boundaries of the ROI based on the input data 115. In such an example, the input data 115 may indicate both the query and the ROI. In another example, the boundary data 134 may be determined based on the sensor data 111 from the sensor 110 that indicates a sensed condition that is indicative of the ROI, the image data 113, the input data 115, or a combination thereof. In some aspects, processor 108 includes the ROI detector 122, and the ROI detector 122 detects a boundary associated with the ROI and generates the boundary data 134. Additional details of detecting the ROI are described further herein with reference to FIG. 2.

The ROI engine 124 receives the model input data 132 and the boundary data 134 and selectively modifies the model input data 132 based on the boundary data 134 to generate the modified model input data 136. For example, the ROI engine 124 may determine whether the boundaries represented by the boundary data 134 satisfy one or more thresholds or criteria and, if the boundaries satisfy the threshold(s) or criteria, the ROI engine 124 may modify the model input data 132 to generate the modified model input data 136 that is provided as input to the multimodal model 126. Alternatively, if the boundaries fail to satisfy the threshold(s) or criteria, the ROI engine 124 may provide the model input data 132 as input to the multimodal model 126. The modification of the model input data 132 performed by the ROI engine 124 to generate the modified model input data 136 may include changing one or more values or portions of the model input data 132, removing one or more values or portions of the model input data 132, adding additional values or data to the model input data 132, adding one or more hyperparameters to the model input data 132, or a combination thereof. Such modifications may be made in accordance with formatting rules or criteria associated with inputs to the multimodal model 126.

In some embodiments, the ROI-aware tile adjuster 140 generates the ROI-aware tile data 142 and includes the ROI-aware tile data 142 in the modified model input data 136 (e.g., replacing at least some of the tile data included in the model input data 132). For example, the ROI-aware tile adjuster 140 may determine, based on the boundaries indicated by the boundary data 134, whether the ROI extends across multiple tiles (e.g., more than one tile) represented by the model input data 132, and if the ROI extends across more than one tile, the ROI-aware tile adjuster 140 modifies the size of the tiles that include the ROI to generate the ROI-aware tile data 142. To illustrate, the ROI-aware tile adjuster 140 may modify (e.g., increase) a size of a first tile that includes a larger portion of the ROI such that, after modification of the size of the first tile, the first tile includes an entirety of the ROI. Additionally, the ROI-aware tile adjuster 140 may modify (e.g., decrease) a size of a second tile that includes a smaller portion of the ROI such that, after modification of the size of the second tile, the second tile does not include the ROI.

In some embodiments, the ROI injector 144 determines whether the boundaries represented by the boundary data 134 satisfy one or more thresholds or criteria, and if the boundaries satisfy the threshold(s) or criteria, the ROI injector 144 generates the ROI feature data 146 and includes the ROI feature data 146 in the modified model input data 136. Inclusion of the ROI feature data 146 in the modified model input data 136 injects the ROI into input data provided to the multimodal model 126 in a format that is acceptable to the multimodal model 126 even if the multimodal model 126 is not pretrained to focus on a ROI in an image. For example, the ROI feature data 146 may include a patch (e.g., a tile) that includes the ROI and that is scaled to satisfy the height and width criteria associated with input to the multimodal model 126 while also preserving the aspect ratio of the ROI. In some aspects, the ROI injector 144 may enhance the ROI by upscaling or downscaling the patch, in an aspect-ratio preserving manner, that also maintains a high definition associated with the original image. Examples of injecting and enhancing the patch that includes the ROI are further described herein with reference to FIGS. 2, 5, and 7.

In some embodiments, the attention modulator 148 obtains (e.g., generates or modifies) the hyperparameters 150 and includes the hyperparameters 150 in the modified model input data 136 (or provides the hyperparameters 150 to the multimodal model 126 separately from the modified model input data 136). The hyperparameters 150 are indicative of a weighting of features associated with the ROI relative to a weighting of features of the image for areas outside the ROI. For example, the hyperparameters 150 may indicate that features associated with the ROI (e.g., the ROI feature data 146) have a first relative weighting value, features associated with the tiles, the context image, the query, or a combination thereof, have a second relative weighting value that is less than the first relative weighting value, and optionally that other features (e.g., padding features or other features) have a third relative weighting value that is less than the second relative weighting value. Additional details of the hyperparameters 150 are further described herein with reference to FIG. 6.

The multimodal model 126 receives the modified model input data 136 (or the model input data 132 if no modifications are performed) and generates the response output 138 based on the modified model input data 136 (or the model input data 132). As further described with reference to FIG. 3, the multimodal model 126 may include image models (e.g., image encoders) and a text model (e.g., an LLM), and the multimodal model 126 may convert input image features of the modified model input data 136 (or the model input data 132) to a common token space into which text features of the modified model input data 136 (or the model input data 132) are also mapped. After the features are mapped to the common token space, the tokens may be flattened and concatenated to be provided as inputs to the text model, as further described with reference to FIG. 6, to generate the response output 138. The response output 138 represents an answer to the question (e.g., query) indicated by the input data 115 using information on which the multimodal model 126 is trained and with a focus on the ROI indicated by the boundary data 134 if the modified model input data 136 is provide as input to the multimodal model 126.

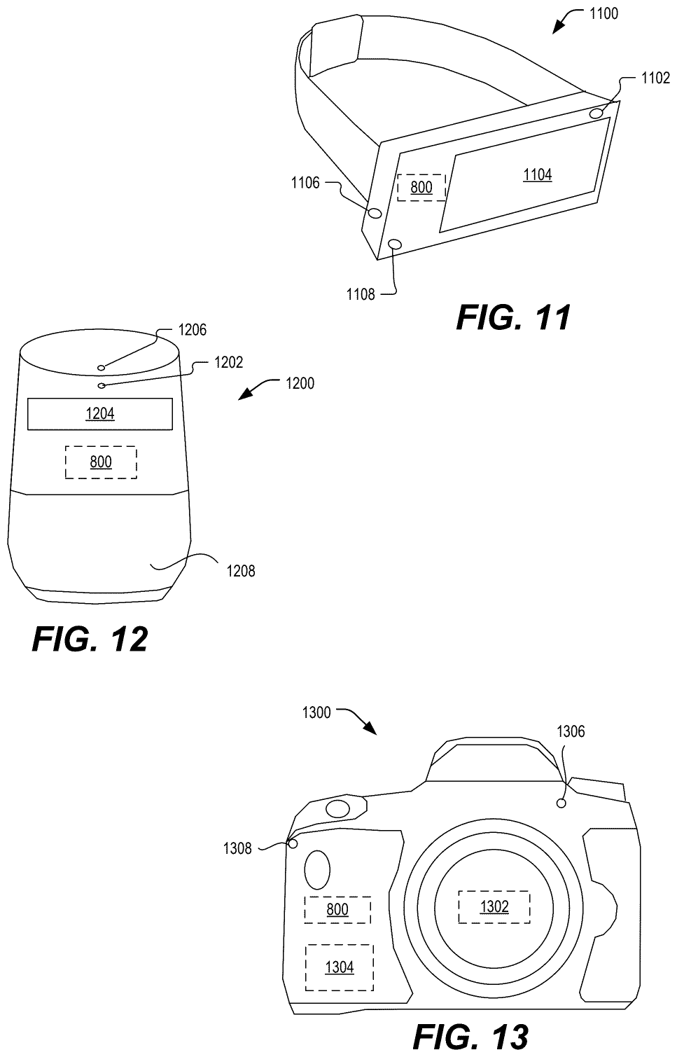

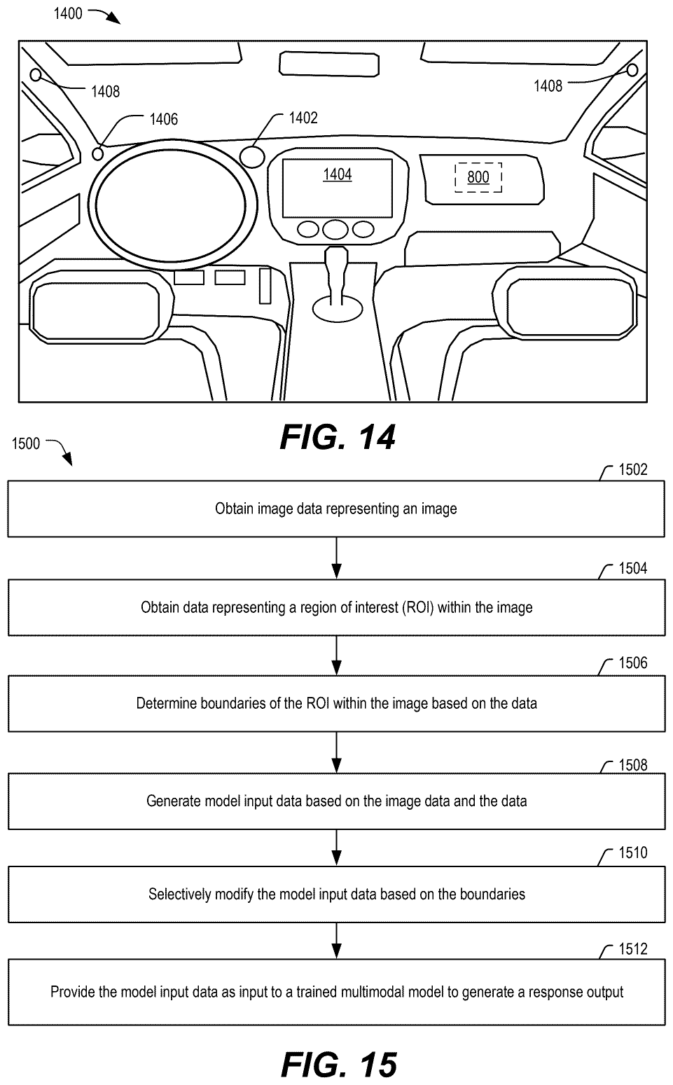

In some examples, the device 102 corresponds to or is included in one of various types of devices, such that the processor 108 can be integrated in multiple types of devices. In an illustrative example, the processor 108 is integrated in a wearable electronic device as depicted in FIG. 11, a virtual reality, mixed reality, or augmented reality headset as depicted in FIG. 10, or another wearable device. In another illustrative example, the processor 108 is integrated in a mobile device (a mobile phone or a tablet) as depicted in FIG. 9, a voice-controlled speaker system as depicted in FIG. 12, a camera as depicted in FIG. 13, a vehicle as depicted in FIG. 14, a computer or a server, or another system or device.

In a particular example, the device 102 includes a memory (e.g., the memory 106) configured to store model data (e.g., the model data 130) associated with a trained multimodal model (e.g., the multimodal model 126). The device 102 also includes one or more processors (e.g., the processor 108) coupled to the memory. The one or more processors are configured to obtain image data (e.g., the image data 113) representing an image associated with a query. The one or more processors are also configured to obtain data (e.g., the input data 115, and optionally the sensor data 111) representing the query and a ROI within the image. The one or more processors are also configured to determine boundaries (e.g., the boundary data 134) of the ROI within the image based on the data. The one or more processors are also configured to generate model input data (e.g., the model input data 132) based on the image data and the data. The one or more processors are also configured to selectively modify the model input data (e.g., to generate the modified model input data 136) based on the boundaries. The one or more processors are also configured to provide the model input data (e.g., the modified model input data 136 or the model input data 132) as input to the trained multimodal model to generate a response output (e.g., the response output 138) associated with the query.

One technical advantage of implementing the device 102 as described above is that the response output 138 that is output by the device 102 has improved accuracy and utility as compared to responses of multimodal models that are not able to support inference-time ROI processing. The increases in accuracy and utility of the response output 138 can be achieved without the costs associated with re-training the multimodal model 126 or with initially fine-tuning the multimodal model 126 to focus on particular locations or types of regions in images. For example, the device 102 (e.g., the ROI engine 124) can support inference-time ROI-focus for the multimodal model 126 without having the computer resources associated with retraining the multimodal model 126. Additionally, because the multimodal model 126 is not fine-tuned to focus on specific locations or types of regions in images, the device 102 provides greater flexibility for use in a variety of situations because there is no associated loss of generality from fine-tuning the multimodal model 126 to provide the inference-time ROI processing capability.

FIG. 2 is a block diagram of an example of components 200 of a device operable to enable ROI processing by a trained model at inference-time, in accordance with one or more aspects of the present disclosure. The components 200 include a ROI detector 202, an OCR module 204, a tiled images extractor 206, a context image extractor 208, an input processor 210, an ROI-aware tile adjuster 212, an ROI injector 214 that includes an ROI enhancer 216, an attention modulator 218, and a pretrained multimodal model 220. In some embodiments, the components 200 of FIG. 2 include or correspond to components of the device 102 of FIG. 1. For example, the ROI detector 202 may include or correspond to the ROI detector 122. The tiled images extractor 206, the context image extractor 208, the input processor 210, and the OCR module 204 may include or correspond to the model input generator 120. The ROI-aware tile adjuster 212 may include or correspond to the ROI-aware tile adjuster 140. The ROI injector 214 may include or correspond to the ROI injector 144. The attention modulator 218 may include or correspond to the attention modulator 148. The pretrained multimodal model 220 may include or correspond to the multimodal model 126.

Each of components 200, or portion(s) thereof, may be implemented by a processor (e.g., the processor 108) executing instructions (e.g., software), dedicated hardware (e.g., circuitry), a combination thereof. Additionally, or alternatively, although illustrated in FIG. 2 as separate components, in other embodiments, one or more of the ROI detector 202, the OCR module 204, the tiled images extractor 206, the context image extractor 208, the input processor 210, the ROI-aware tile adjuster 212, the ROI injector 214, the ROI enhancer 216, the attention modulator 218, or the pretrained multimodal model 220 may be included in or integrated within a single component that is configured to perform the operations described with reference to the respective components.

The ROI detector 202 is configured to receive image data 230 (which may include or correspond to the image data 113), such as from a camera, a memory, or another image source, and to generate boundary data 234 that represents boundaries of an ROI within an image represented by the image data 230. In some embodiments, the ROI detector 202 determines the boundaries based on user input that indicates selection of the ROI. For example, the ROI detector 202 may receive user input data (e.g., the input data 232) that indicates a selected ROI, such as data generated by a touchscreen when a user traces the boundaries of the ROI with a finger or a stylus. As another example, the user input may include or correspond to text data that describes the boundaries, and the ROI detector 202 may generate the boundary data 234 based on the text data.

In some aspects, the ROI detector 202 is configured to receive sensor data (not shown in FIG. 2) that indicates the ROI. For example, the ROI detector 202 may receive sensor data (e.g., the sensor data 111) from an orientation sensor, a gaze tracking system, an accelerometer, a velocity sensor, an IMU, an audio capture device (e.g., a microphone), or another type of sensor, and the ROI detector 202 may process the sensor data to determine the boundaries of the ROI represented by the sensor data. As a particular example, the ROI detector 202 may receive gaze data from a gaze tracking system that tracks a direction of the user's gaze, and the ROI detector 202 may identify a region of an image that is captured by a camera in the same direction as the user's gaze that corresponds to the center of the user's gaze. The boundary data 234 may include or indicate boundaries of the identified region.

As another example, one or more of the components 200 may be included in a head-mounted device such as a headset, a glasses device, or the like, and the ROI detector 202 may receive orientation data from an orientation sensor of the head-mounted device that indicates an orientation of the user. The ROI detector 202 may determine a region of an image (e.g., from one or more cameras of the head-mounted device) that corresponds to the user's gaze based on the orientation data, and boundaries of the identified region may be output as the boundary data 234. As another example, the ROI detector 202 may receive audio data from a microphone or other audio capture device or sensor, and the ROI detector 202 may process the audio data to identify user speech that includes a description of the ROI. In such an example, the ROI detector 202 may include or have access to a natural language processing (NLP) module that processes the user speech to identify the ROI, and boundaries of the ROI may be output as the boundary data 234. The above-described examples are illustrative, and in other embodiments, the ROI detector 202 may determine the boundary data 234 based on other sensor data from other sensors or using other techniques. The boundary data 234 may be provided to the OCR module 204, the ROI-aware tile adjuster 212, and the ROI injector 214, and optionally, to the pretrained multimodal model 220 (if the boundary data 234 can be included in model input data).

The tiled images extractor 206 is configured to divide (e.g., logically allocate portions of) the image represented by the image data 230 into a set of one or more tiles to generate the tile data 236. Each tile of the set of tiles represented by the tile data 236 has a corresponding size, and optionally a corresponding aspect ratio, that is based on a size criterion associated with an image encoding and mapping model of the pretrained multimodal model 220 (and optionally an aspect ratio criterion). For example, the tiled images extractor 206 may determine that, based on the size of the image, the image includes four tiles having a particular size specified for input to the pretrained multimodal model 220. In such an example, the tiled images extractor 206 may divide the image into four equally-sized tiles to generate the tile data 236. In some embodiments, the tiled images extractor 206 is configured to receive a high resolution version of the image data 230, and the tiles represented by the tile data 236 are high-resolution image portions. The tile data 236 may be provided to the OCR module 204 and the ROI-aware tile adjuster 212. In some embodiments, the tiled images extractor 206 and the ROI-aware tile adjuster 212 are omitted from the components 200, and the OCR module 204 is provided output from the context image extractor 208.

The context image extractor 208 is configured to generate context image data 244 that represents the image as a whole (e.g., a context image) in a format that conforms to an input specification of the pretrained multimodal model 220. For example, the context image extractor 208 may upscale or downscale a size of the image represented by the image data 230 to the particular size specified for input to the pretrained multimodal model 220, and the context image extractor 208 may pad the image (e.g., add padding pixels to regions at the top, the left, the right, or the bottom of the image) such that an aspect ratio of the context image is the same as a particular aspect ratio specified for input to the pretrained multimodal model 220 (e.g., the aspect ratio satisfies an aspect ratio criterion). In some embodiments, the context image extractor 208 is configured to receive or output a lower resolution version of the image data 230 (or the context image represented by the context image data 244), as compared to the tiles represented by the tile data 236. The context image data 244 may be provided as part of model input data (e.g., the model input data 132 or the modified model input data 136) to the pretrained multimodal model 220.

The input processor 210 is configured to process input data 232 to generate query text data 246. In some embodiments, the input data 232 includes or corresponds to a user input that indicates a question (e.g., a query) that the user is providing to the pretrained multimodal model 220 to receive a response. For example, the input data 232 may include text data based on a user input received via a touchscreen, a keypad, or the like, and the input processor 210 may perform one or more text processing operations, including formatting, NLP, feature extraction, or a combination thereof, to generate the query text data 246. Additionally, in some aspects, the input data 232 may include or correspond to user input that represents the ROI, and the input processor 210 may process the associated text data and provide the processed text data to the ROI detector 202 for use in generating the boundary data 234. In some other embodiments, the input data 232 includes audio data that is captured by a microphone and that includes user speech that represents the query, and the input processor 210 may perform one or more audio processing operations, speech-to-text conversion operations, NLP or other text processing operations, or a combination thereof, to generate the query text data 246. The query text data 246 may be provided as part of model input data (e.g., the model input data 132 or the modified model input data 136) to the pretrained multimodal model 220.

The OCR module 204 is configured to generate ROI text data 238 based on any text that appears in the ROI. For example, the OCR module 204 may perform one or more OCR operations on one or more tiles represented by the tile data 236 that include the ROI (as indicated by the boundary data 234) to read any text within the ROI and to output the resulting text as the ROI text data 238. The ROI text data 238 may be provided as part of model input data (e.g., the model input data 132 or the modified model input data 136) to the pretrained multimodal model 220. Although illustrated as receiving the boundary data 234 and the tile data 236, in other embodiments, the OCR module 204 may receive the boundary data 234 and the image data 230, and the OCR module 204 may perform the OCR operation(s) on the ROI in the image based on the boundary data 234. Alternatively, the OCR module 204 may receive ROI image data 242 from the ROI injector 214 that represents a patch that includes the ROI, and the OCR module 204 may perform the OCR operation(s) on the ROI image data 242. Although shown in FIG. 2 as being included in the components 200, in other embodiments, the components 200 do not include the OCR module 204 (e.g., the OCR module 204 and the ROI text data 238 are optional).

The ROI-aware tile adjuster 212 is configured to selectively adjust boundaries of one or more of the tiles represented by the tile data 236 based on the boundaries represented by the boundary data 234. For example, the ROI-aware tile adjuster 212 may be configured to determine, based on the boundaries, whether the ROI extends across multiple tiles of the set of tiles represented by the tile data 236. If the ROI extends across multiple tiles, the ROI-aware tile adjuster 212 adjusts the boundaries of the multiple identified tiles to generate ROI-aware tile data 240. Alternatively, if the ROI does not extend across multiple tiles, the ROI-aware tile adjuster 212 maintains the initial tile boundaries and passes the tile data 236 through as the ROI-aware tile data 240. The ROI-aware tile data 240 is provided as part of model input data (e.g., the model input data 132 or the modified model input data 136) to the pretrained multimodal model 220.

As an example of ROI-aware tile boundary adjustment, the ROI-aware tile adjuster 212 may be configured to determine whether the ROI extends across multiple tiles and, based on the ROI extending across multiple tiles, modify a size of a first tile of the multiple tiles such that, after modification of the size, the first tile includes an entirety of the ROI. To illustrate, the ROI-aware tile adjuster 212 may increase a size of the first tile such that an entirety of the ROI is included in the first tile. In this example, the ROI-aware tile adjuster 212 is also configured to, based on the ROI extending across multiple tiles and for each tile of one or more other tiles included in the multiple tiles, modify a size of the tile such that the ROI is not included in the tile. To illustrate, the ROI-aware tile adjuster 212 may decrease a size of each other tile that included a respective portion of the ROI such that each of the other tiles does not include any portion of the ROI and such that a combined size of the modified first tile and the modified other tiles is the same as a combined size of the first tile and the other tiles, prior to modification. Additional details of ROI-aware tile boundary adjustment are described further herein, with reference to FIG. 4.

The ROI injector 214 is configured to generate ROI image data 242 based on the image data 230 and the boundary data 234. The ROI image data 242 may include a patch (similar to a tile/having a same size and aspect ratio) that is extracted from the image represented by the image data 230 and that includes an entirety of the ROI (e.g., a scaled version of the ROI) as determined based on the boundaries of the ROI that are indicated by the boundary data 234. In some aspects, the ROI injector 214 selectively generates the ROI image data 242 based on the boundary data 234. For example, if the boundary data 234 indicates that the ROI size is less than the particular size associated with an input specification of the pretrained multimodal model 220, the ROI injector 214 upscales the ROI patch to generate the ROI image data 242. As another example, if the boundary data 234 indicates that the ROI size is greater than the particular size and that an aspect ratio of the ROI is the same as a particular aspect ratio associated with an input specification of the pretrained multimodal model 220 (such that the ROI patch can be downscaled while maintaining the aspect ratio), the ROI injector 214 downscales the ROI patch to generate the ROI image data 242. In yet another example, if the ROI size is equal to the particular size and the ROI aspect ratio is equal to the particular aspect ratio, the ROI injector 214 outputs the ROI image data 242 corresponding to the ROI patch (e.g., unscaled or scaled by 1).

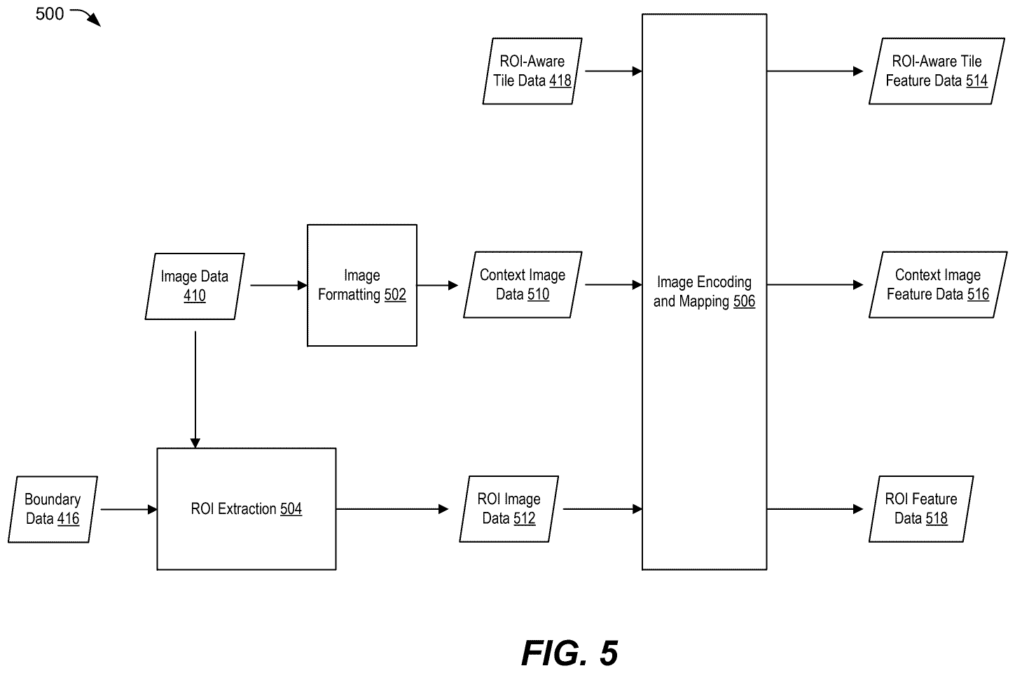

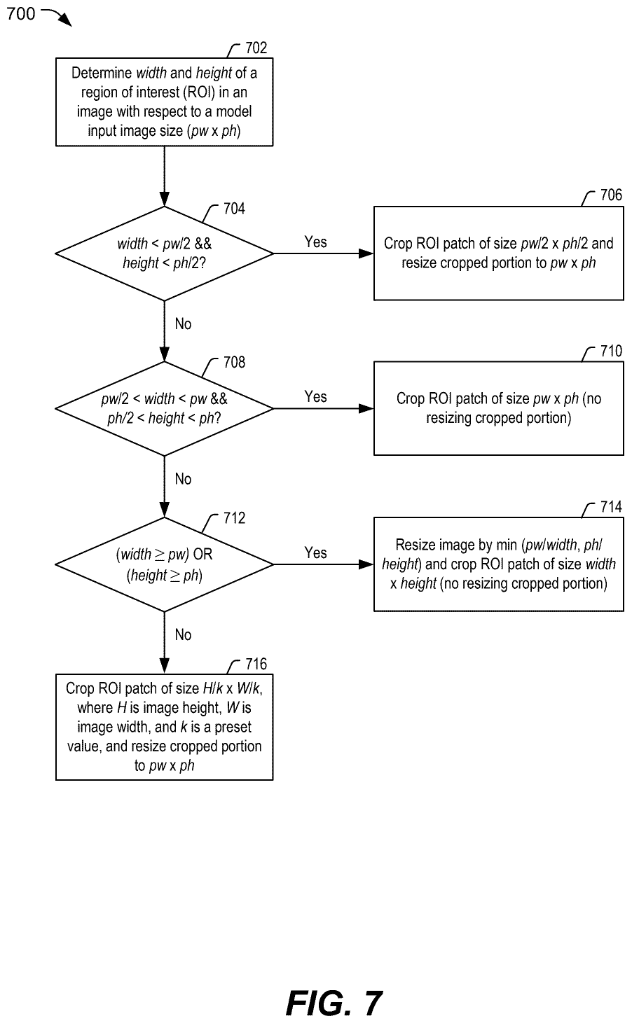

The ROI injector 214 provides the ROI image data 242 as part of model input data (e.g., the modified model input data 136) to the pretrained multimodal model 220. Alternatively, if the ROI size is greater than or equal to the particular size (e.g., a certain percentage of the image), the ROI injector 214 does not generate the ROI image data 242 such that the model input data for the pretrained multimodal model 220 does not include an ROI patch (e.g., a portion of image data that includes a scaled version of the ROI and does not include areas outside the ROI). The ROI enhancer 216 may be configured to enhance the ROI patch by scaling the patch in an aspect ratio-preserving manner, padding the patch, or a combination thereof, to reduce or eliminate information loss from the ROI due to differences in the size or aspect ratio of the ROI and those of an input specification of the pretrained multimodal model 220. Additional details and examples of ROI injection and enhancement are further described herein with reference to FIGS. 5 and 7.

The attention modulator 218 is configured to obtain hyperparameters 248 (e.g., one or more hyperparameter values of the pretrained multimodal model 220) that are indicative of a weighting of features associated with the ROI (e.g., features included in or derived from the ROI image data 242 and optionally the ROI text data 238) relative to a weighting of features of the image for areas outside the ROI and/or other input features (e.g., features included in or derived from the ROI-aware tile data 240, the context image data 244, and the query text data 246). For example, prior to operation of the attention modulator 218, hyperparameter values associated with an attention tensor at the pretrained multimodal model 220 may be configured such that one relative weighting value (e.g., a null value) is assigned to padding and other unused or less useful features, and a different relative weighting value (e.g., 0) indicating a greater weight is assigned to input image features that include visual information, input text features, and query features. The hyperparameters 248 generated by the attention modulator 218 may increase the relative weighting of ROI-related features as compared to the already higher-weighted features, such as by assigning a new relative weighting value (e.g., 0.5) to the ROI-related features that is greater than the relative weighting value (e.g., null or 0) associated with the above-mentioned features. The hyperparameters 248 may modify or replace hyperparameters at the pretrained multimodal model 220 and be provided as part of model input data (e.g., the modified model input data 136) to the pretrained multimodal model 220.

In some aspects, one or more of the components 200 are configured to selectively modify model input data to include ROI-aware data or ROI-related data, similar to as described above with reference to FIG. 1. For example, if no ROI-related modification is performed, model input data (e.g., the model input data 132) that is provided to the pretrained multimodal model 220 may include the tile data 236 (e.g., the ROI-aware tile adjuster 212 passes the tile data 236 through as the ROI-aware tile data 240), the context image data 244, the query text data 246, and unmodified hyperparameters. However, if ROI-related modifications are performed, modified model input data (e.g., the modified model input data 136) that is provided to the pretrained multimodal model 220 may include the ROI-aware tile data 240 (that is different from the tile data 236), the ROI text data 238, the ROI image data 242, the hyperparameters 248, or a combination thereof, in addition to the context image data 244 and the query text data 246. The pretrained multimodal model 220 may receive the respective input data and generate a response output 250 that answers the query indicated by the query text data 246 and that is based on the image data 230, and in some examples, an ROI within an image. For example, the response output 250 may include or correspond to the response output 138 of FIG. 1.

FIG. 3 is a block diagram of an example of a pretrained multimodal model 300 that supports inference-time ROI processing, in accordance with one or more aspects of the present disclosure. In some examples, the pretrained multimodal model 300 of FIG. 3 may include or correspond to the multimodal model 126 of FIG. 1, the pretrained multimodal model 220 of FIG. 2, or both. In some embodiments, the pretrained multimodal model 300 includes or corresponds to an LMM, particularly an “off-the-shelf” or pretrained LMM that is not trained or fine-tuned to focus on particular portions or features of images. Conventional LMMs (e.g., off-the-shelf LMMs) typically accept an image-question pair and output an answer to the question, but are not designed to accept a user-defined ROI either during training nor during inference (or otherwise while designing the architecture of the LMM). Although described herein as including one or more image models and a text model, in other embodiments, the pretrained multimodal model 300 may include more than one set of image models, more than one text model, additional types of models, or a combination thereof. Alternatively, the operations described with reference to the one or more image models may be performed by separate models or other processes in some other embodiments, and the output of the separate models and other inputs may be provided as model input data to a text model.

In the example depicted in FIG. 3, the pretrained multimodal model 300 includes an image encoder 302, a mapper 304, a text tokenizer 306, and a language model 308. Although illustrated in FIG. 3 as separate components, the image encoder 302 and the mapper 304 may alternatively be integrated together as an image encoding and mapping model. The image encoder 302 is trained to generate text data or text features that represent image(s) or image features (e.g., to perform image-to-text encoding). In some embodiments, the image encoder 302 may be trained using contrastive learning or next-token prediction. The mapper 304 is configured to map the text data or text features output by the image encoder 302 to a common token space that is associated with the text tokenizer 306. For example, the mapper 304 may be configured to generate a first sequence of tokens (e.g., first feature data) based on input text data or text features. As such, the mapper 304 may be a tokenizer or configured to perform mapping and tokenizing operations on input text (or text features). The text tokenizer 306 is configured to map input text data (or text features) that represent a query, or other information, into a common token space with the output of the mapper 304. For example, the text tokenizer 306 may be configured to generate a second sequence of tokens (e.g., second feature data) based on input text data (or text features), and the first and second token streams may be in the same token space.

The language model 308 is configured to receive a sequence of tokens as input (e.g., a concatenation of the first feature data output by the mapper 304 and the second feature data output by the text tokenizer 306) and to generate a response to a question represented by the input token stream and based at least partly on an image indicated by the input token stream. In some embodiments, the language model 308 includes or corresponds to an LLM. In some aspects, the language model 308 is not trained to generate responses based on particular regions of images or fine-tuned in such a manner, as described above with reference to FIG. 1. As can be appreciated, the combination of the image encoder 302, the mapper 304, the text tokenizer 306, and the language model 308 can be considered as a simplified black-box interface that receives an image and question (and due to the techniques described herein, a ROI) and that outputs an answer to the question.

During operation, the pretrained multimodal model 300 may receive modified model input data 310 that includes image related data 312 and text data 314. In some examples, the modified model input data 310 includes or corresponds to the modified model input data 136 of FIG. 1 or a combination of at least some of the ROI-aware tile data 240, the ROI image data 242, the ROI text data 238, the context image data 244, the query text data 246, and the hyperparameters 248 of FIG. 2. The modified model input data 310 may represent an image, an ROI within the image, and a query (e.g., a question) that is to be answered at least partially based on the image and the ROI. For example, the image related data 312 may include image tiles, ROI-aware image tiles, a context image patch, an ROI patch, or a combination thereof, and the text data 314 may include text that represents a query and, optionally, text that is detected in a ROI. The image related data 312 is provided to the image encoder 302 for encoding to text data and subsequently to the mapper 304 for generation of first feature data (e.g., a first sequence of tokens). The text data 314 is provided to the text tokenizer 306 for generation of second feature data (e.g., a second sequence of tokens) in the same feature space (e.g., token space) as the feature space of the first feature data. The first feature data and the second feature data may be combined (e.g., flattened and concatenated) and provided as input to the language model 308, and the language model 308 may generate a response output 316 that represents an answer to the query represented by the modified model input data 310. For example, the response output 316 may include or correspond to the response output 138 of FIG. 1, the response output 250 of FIG. 2, or both.

FIG. 4 is a diagram of an example of operations 400 that enable ROI processing by a trained model at inference-time, in accordance with some aspects of the present disclosure. The operations 400 depicted in FIG. 4 may be performed by a device that is configured to enable ROI processing by a trained model at inference-time, or components thereof. For example, one or more of the operations 400 may be performed by the model input generator 120, the ROI detector 122, the ROI engine 124, the ROI-aware tile adjuster 140, the processor 108, the device 102, the system 100 of FIG. 1, the ROI detector 202, the tiled images extractor 206, the context image extractor 208, the ROI-aware tile adjuster 212 of FIG. 2, or a combination thereof.

Conventional LMMs perform image tiling on an input image to process a high-resolution image and to provide tiles that satisfy a size criterion and/or an aspect ratio criterion of the LMM (e.g., of an image encoder). This image tiling process is performed independently of an ROI, which can sometimes result in fragmenting the ROI across multiple tiles. For example, if the bounding box of the ROI crosses multiple tiles, the ROI may be divided among multiple tiles. This fragmentation poses challenges for the typical LMM in obtaining accurate answers related to information within the ROI. For example, if text is located within an ROI, fragmenting the ROI across multiple tiles may result in an incorrect determination of the text using tile-specific OCR operations. To prevent or reduce the likelihood of mistakes or information loss resulting from fragmentation of the ROI across multiple tiles, the operations 400 include selectively adjusting tile boundaries such that the tile boundaries respect the ROI boundaries (e.g., such that an entirety of the ROI is included in a single tile) to avoid fragmenting the ROI.

The operations 400 include image formatting 402, tiled images extraction 404, and ROI-aware tile boundary adjustment 406. The image formatting 402 may include receiving image data 410 that represents an image and performing one or more formatting operations to generate formatted image data 412 that represents a formatted image. For example, the image formatting 402 may include padding the image, resizing the image, other image manipulation or formatting of the image, or a combination thereof, such that the formatted image has dimensions that satisfy, or are multiples of, dimension criteria (e.g., size criteria) associated with an input specification of a multimodal model, an aspect ratio that satisfies, or is a multiple of, an aspect ratio criterion associated with the input specification of the multimodal model, or a combination thereof. To illustrate, the model input generator 120 or the tiled images extractor 206, the context image extractor 208, or both may add padding to the image, resize the image, otherwise alter the image, or a combination thereof, to generate the formatted image. For example, padding may be added to the top, the bottom, or both, of the image to increase the height of the image. As another example, padding may be added to the left side, the right side, or both, of the image to increase the width of the image. Adding padding to the image prior to resizing the image may reduce or prevent aliasing artifacts when resizing the image to generate the formatted image. For example, by adding padding to the image, the resizing can preserve the aspect ratio of the image. In a particular example, the formatted image may have dimensions that are twice the respective dimensions associated with an input specification of the multimodal model. In other examples, the formatted image has different dimensions and/or aspect ratios that are based on the dimension criteria and the aspect ratio criterion, respectively.

The tiled images extraction 404 may include receiving the formatted image data 412 that represents the formatted image and dividing (e.g., logically designating portions of) the formatted image into one or more tiles to generate tile data 414 that represents the tiles (e.g., portions of the formatted image). For example, the tiled images extraction 404 may include splitting the formatted image into rows and columns that together divide the image into multiple different tiles in the various rows and columns. Each of the tiles may have dimensions and aspect ratios that satisfy the dimension criteria and the aspect ratio criterion, respectively, associated with the input specification of the multimodal model. To illustrate, the model input generator 120 or the tiled images extractor 206 may divide the formatted image into multiple tiles that are represented by the tile data 414. In a particular example, the formatted image may be split into two rows and two columns, such that four tiles are extracted. In other examples, the formatted image can be split into fewer than two or more than two rows, fewer than two or more than two columns, or both, and fewer than four or more than four tiles may be extracted in such examples.

The ROI-aware tile boundary adjustment 406 may include receiving the tile data 414 that represents the tiles, receiving boundary data 416 that indicates boundaries of a ROI, and selectively adjusting boundaries of the tiles based on the boundaries of the ROI to generate ROI-aware tile data 418 that represents the tiles after any modifications to cause the ROI to be contained within a single tile. For example, the ROI-aware tile boundary adjustment 406 may include determining whether the ROI extends across multiple tiles, and if so, defining (or redefining) tile boundaries such that the ROI does not extend across multiple tiles (e.g., such that an entirety of the ROI is included in a single tile). This tile boundary adjustment may respect one, or both, of the following constraints: 1) minimizing the area of the tile that contains the ROI; and 2) causing the aspect ratio of each boundary-adjusted tile to be as similar as possible to the aspect ratio criterion (e.g., to minimize changes to the aspect ratios of the boundary adjusted tiles) of the multimodal model. To illustrate, the ROI-aware tile adjuster 140 or the ROI-aware tile adjuster 212 may adjust the tile boundaries of some of the tiles if the ROI extends across multiple tiles to generate the ROI-aware tile data 418. After modifying any tile boundaries, the tiles with modified tile boundaries are resized to satisfy the dimension criteria and the aspect ratio criterion, respectively, associated with an input specification of the multimodal model. Additionally, or alternatively, padding may be added to the tiles with modified tile boundaries, either prior to or instead of, resizing these tiles. For example, padding may be added to the top, the bottom, or both, of a tile to increase the height of the tile. As another example, padding may be added to the left side, the right side, or both, of a tile to increase the width of the tile.

FIG. 4 also depicts a first example 430 of image tiling without respect to an ROI and a second example 450 of ROI-aware image tiling. In the first example 430, an image 432, I_{H,W}, to be processed by a multimodal model has a height H and a width W, and an input specification indicating dimension criteria of inputs to the multimodal model may specify that input images have a height ph and a width pw. To preserve the aspect ratio of the image 432, the image 432 is padded and then resized to have a height h and a width w, resulting in a resized image 434 (I_{h,w}) that includes padding 436. The height h and width w may be selected as multiples of pw and ph, respectively (in this example, h=2ph and w=2pw). The image 432 includes a ROI, that corresponds to ROI 438 in the resized image 434, which may be a user-selected ROI or an ROI identified based on an application executing at the device, such as a game application, an extended reality application, or the like.

After the padding and resizing, the resized image 434 is split into two rows and two columns to divide the resized image 434 into four tiles: a first tile 440 extracted from an upper-left quadrant of the resized image 434, a second tile 442 extracted from an upper-right quadrant of the resized image 434, a third tile 444 extracted from a lower-left quadrant of the resized image 434, and a fourth tile 446 extracted from a lower-right quadrant of the resized image 434. The height and the width of each of the tiles 440-446 are ph and pw, respectively, and thus the tiles 440-446 conform to the criteria associated with inputs to the multimodal model. However, because of the location of the ROI 438, the ROI 438 extends across multiple of the tiles 440-446. For example, a first portion (e.g., a larger portion) of the ROI 438 is included in the second tile 442 and a second portion (e.g., a smaller portion) of the ROI 438 is included in the fourth tile 446. As explained above, fragmenting the ROI 438 across multiple images (e.g., the second tile 442 and the fourth tile 446) can cause inaccuracies to a multimodal model that processes the images.

In the second example 450, instead of dividing the resized image 434 into four tiles having the same size, the boundaries of the second tile 442 and the fourth tile 446 are adjusted such that the ROI 438 is completely contained within one tile, in this example a modified second tile 452. For example, the height of a modified second tile 452 may be greater than the height of the second tile 442 such that an entirety of the ROI 438 is contained within the modified second tile 452. Additionally, the boundaries of other tiles that include a respective portion of the ROI 438 may be adjusted such that these tiles no longer include any portion of the ROI 438. For example, the height of a modified fourth tile 454 may be less than the height of the fourth tile 446 such that the modified fourth tile 454 does not include any portion of the ROI 438. The boundary modifications may be selected to minimize the area of the modified second tile 452 (e.g., the tile that includes the ROI 438) and/or to keep the aspect ratios of the modified second tile 452 and the modified fourth tile 454 as similar to ph×pw as possible. After modifying the tile boundaries, the tiles with the modified boundaries are resized based on the dimension criteria and the aspect ratio criterion of the multimodal model to generate a resized second tile 456 and a resized fourth tile 458. In this example, the height of each of the resized tiles 456, 458 is ph and the width of each of the resized tiles 456, 458 is pw, such that the resized tiles 456, 458 conform to the criteria associated with inputs to the multimodal model. In this example, the first tile 440, the resized second tile 456, the third tile 444, and the resized fourth tile 458 are provided to the multimodal model as the ROI-aware tile data 418.

FIG. 5 is a diagram of an example of additional operations 500 that enable ROI processing by a trained model at inference-time, in accordance with some aspects of the present disclosure. The operations 500 depicted in FIG. 5 may be performed by a device that is configured to enable ROI processing by a trained model at inference-time, or components thereof. For example, one or more of the operations 500 may be performed by the ROI engine 124, the ROI injector 144, a portion of the multimodal model 126, the processor 108, the device 102, the system 100 of FIG. 1, the ROI injector 214, the ROI enhancer 216, a portion of the pretrained multimodal model 220 of FIG. 2, the image encoder 302, the mapper 304, a portion of the pretrained multimodal model 300 of FIG. 3, or a combination thereof.

Conventional LMMs were not trained to accept a user-defined ROI in an image as an input. Because of this, these LLMs do not accept inputs that can focus the LLMs to OCR text in particular regions of the image, which can result in degraded OCR capabilities due to image tiling or aliasing artifacts from scaling images to satisfy size and aspect ratio criteria. Additionally, these LLMs do not accept inputs that can indicate that the answer to a question is more likely in a particular region of the image than in the image as a whole. Although these LMMs can be retrained and fine-tuned to focus on particular regions of images, fine-tuning the LMMs to improve their focus with respect to particular regions comes at a cost: significant performance drop towards the general knowledge comprehension and instruction-following abilities of the LMMs. Additionally, the process of fine-tuning these models is resource-intensive, sometimes requiring thousands of hours of graphical processor unit (GPU) training. As a result, the cost and computational resources needed to retrain and fine-tune the conventional LMMs makes the fine-tuning an impractical choice. To improve the ROI-specific focus of a LMM (or other trained model) and maintain the global context awareness of the model without incurring the costs of fine-tuning, the operations 500 enable ROI-related information to be extracted and injected to model input data of a multimodal model.

The operations 500 include image formatting 502, ROI extraction 504, and image encoding and mapping 506. The image formatting 502 may include receiving the image data 410 that represents the image and performing one or more formatting operations to generate context image data 510 that represents a context image that has dimensions that satisfy the dimension criteria (e.g., size criteria and aspect ratio criterion) associated with input to the multimodal model. For example, the image formatting 502 may include resizing the image (without padding), other image manipulation or formatting of the image, or a combination thereof. To illustrate, the model input generator 120 or the context image extractor 208, may resize the image or otherwise alter the image to generate the context image. The context image may be a lower resolution image that represents an entirety of the image, without information loss due to division, and that does not designate a portion as corresponding to the ROI. Because the image formatting 502 may not preserve the aspect ratio of the image, some aliasing artifacts may be introduced to the context image. However, because the context image represented by the context image data 510 is provided mainly for context of the relationship between features in the higher-definition tiles, such artifacts may not significantly degrade performance of the multimodal model. The context image data 510 may be provided as input to the image encoding and mapping 506.

The ROI extraction 504 may include receiving the image data 410, receiving the boundary data 416, and selectively generating ROI image data 512 that represents at least a portion of the image that includes the entirety of an ROI indicated by the boundary data 416. For example, if the size of the ROI is sufficiently smaller than the size of the image, such that the ROI indicates a portion but not an entirety (or a large portion) of the image, the ROI extraction 504 may extract a patch that includes the ROI and optionally perform one or more resizing or enhancing operations to output the ROI image data 512 that represents the ROI patch (e.g., an ROI tile). To illustrate, the ROI injector 144 or the ROI injector 214 (including the ROI enhancer 216) may determine whether the boundaries represented by the boundary data 416 satisfy one or more thresholds, and the ROI image data 512 may be provided to the image encoding and mapping 506 based on the boundaries satisfying the one or more thresholds. Although the ROI extraction 504 are described in FIG. 5 as a single set of operations, in other embodiments, the ROI extraction and enhancement may be separate operations. Alternatively, if the boundaries fail to satisfy the one or more thresholds, then no ROI image data 512 is output (e.g., the ROI extraction and enhancement are selective).

In some aspects, the ROI extraction 504 includes determining whether the boundaries represented by the boundary data 416 satisfy any of a set of thresholds and, depending on which thresholds are satisfied, performing respective scaling and/or enhancement operations on a portion of the image that includes the ROI within the boundaries to extract a patch that includes an entirety of the ROI. For example, based on a comparison of the boundaries to a first threshold, a patch that includes the ROI may be extracted and upscaled in a manner that preserves an aspect ratio to generate the ROI image data 512. As another example, based on a comparison of the boundaries to a second threshold, a patch that includes the ROI may be extracted and used without scaling to generate the ROI image data 512. As another example, based on a comparison of the boundaries to a third threshold, a patch that includes the ROI may be extracted and downscaled in a manner that preserves an aspect ratio to generate the ROI image data 512. Alternatively, in some rare situations, a patch that is larger than necessary to include the ROI may be extracted and resized to generate the ROI image data 512. Additional details of extracting and scaling or enhancing ROI patches are described herein with reference to FIG. 7.

The image encoding and mapping 506 may include receiving the ROI-aware tile data 418, receiving the context image data 510, receiving the ROI image data 512, proving the inputs to an image encoder model within the multimodal model that converts the various inputs to text data (e.g., text features), and mapping the text data to text features in a common feature space (e.g., token space) that is used by a tokenizer of the multimodal model to generate ROI-aware tile feature data 514, context image feature data 516, and ROI feature data 518. For example, the image encoder model may be trained to perform image-to-text encoding, as explained above, to convert the input image features to text features for tokenization (e.g., mapping) to a common token space, which generates the feature data 514-518. To illustrate, a portion of the multimodal model 126, the processor 108, the device 102, the system 100 of FIG. 1, a portion of the pretrained multimodal model 220 of FIG. 2, the image encoder 302 and the mapper 304, or a portion of the pretrained multimodal model 300 of FIG. 3 may process the ROI-aware tile data 418, the context image data 510, and the ROI image data 512 to generate the ROI-aware tile feature data 514, the context image feature data 516, and the ROI feature data 518, respectively. The ROI-aware tile feature data 514 includes text data that represents the tiles represented by the ROI-aware tile data 418 (in an ROI-aware manner based on modification by the ROI-aware tile boundary adjustment 406), the context image feature data 516 includes text data the represents the context image represented by the context image data 510, and the ROI feature data 518 includes text data the represents the ROI patch represented by the ROI image data 512. The feature data 514-518 may be passed on within the multimodal model to be combined with text features for input to a text model to answer the query associated with the image and the ROI.

FIG. 6 is a diagram of an example of additional operations 600 that enable ROI processing by a trained model at inference-time, in accordance with some aspects of the present disclosure. The operations 600 depicted in FIG. 6 may be performed by a device that is configured to enable ROI processing by a trained model at inference-time, or components thereof. For example, one or more of the operations 600 may be performed by the model input generator 120, the ROI engine 124, the attention modulator 148, a portion of the multimodal model 126, the processor 108, the device 102, the system 100 of FIG. 1, the attention modulator 218, the OCR module 204, the input processor 210, a portion of the pretrained multimodal model 220 of FIG. 2, the text tokenizer 306, the language model 308, a portion of the pretrained multimodal model 300 of FIG. 3, or a combination thereof.

The operations 600 include flattening and concatenating 602, text mapping 604, concatenating 606, and attention modulation 608. The flattening and concatenating 602 may include concatenating the ROI-aware tile feature data 514, the context image feature data 516, and the ROI feature data 518 and “flattening” (e.g., reducing the dimensionality of the input feature data) the concatenation to a dimensionality associated with input to a text model of the multimodal model to generate image-related feature data 612. Alternatively, the input feature data may be flattened and then concatenated. To illustrate, a portion of the multimodal model 126 of FIG. 1, a portion of the pretrained multimodal model 220 of FIG. 2, or a portion of the pretrained multimodal model 300 of FIG. 3 may include a flattening layer that flattens the various input feature data, and the resultant “flattened” feature data is concatenated to generate the image-related feature data 612.

The text mapping 604 may include receiving text data 610 that indicates a query (e.g., a question) to be answered by the multimodal model and generating text feature data 614 that is mapped to the common feature space (e.g., token space) of the output of the image encoding and mapping 506. To illustrate, the model input generator 120 of FIG. 1, the input processor of FIG. 2, or the text tokenizer 306 may process, map, and/or tokenize the text data 610 to generate the text feature data 614. The concatenating 606 may include concatenating the text feature data 614 with the image-related feature data 612 to generate language model input data 616. To illustrate, a portion of the multimodal model 126 of FIG. 1, a portion of the pretrained multimodal model 220 of FIG. 2, or a portion of the pretrained multimodal model 300 of FIG. 3 may concatenate the image-related and text-related feature data to generate the language model input data 616 for input to a language model, such as the language model 308 of FIG. 3. In some embodiments, during the above-described concatenation or flattening, the features related to padding may be removed and discarded. Alternatively, the padding-related features may be removed after the encoding and mapping 506.

In some aspects, the above-described operations may include formatting the language model input data 616 to be accepted by the language model. To illustrate, after flattening, a first portion of the ROI-aware tile feature data 514 that corresponds to the first row of tiles may be concatenated to the end of the context image feature data 516, followed by a first type of separator token (e.g., an image newline token). Next, a second portion of the ROI-aware tile feature data 514 that corresponds to the second row of tiles may be concatenated to the end of the first portion of the ROI-aware tile feature data 514, followed by the first type of separator token. Next, the ROI feature data 518 may be concatenated to the end of the second portion of the ROI-aware tile feature data 514, followed by a second type of separator token (e.g., a sentence newline token). This represents the image-related feature data 612. Next, the text feature data 614 may be concatenated to the end of the image-related feature data 612, followed by the second type of separator token, to generate the language model input data 616.

In addition to the generation of the language model input data 616 (or as part of the process), the attention modulation 608 may include obtaining hyperparameters 618 (e.g., one or more hyperparameter values) that are indicative of a relative weighting of the various input features to the text model. The values of the hyperparameters 618 may be set such that input features associated with the ROI are more heavily weighted relative to features of the image for areas outside the ROI, and optionally, the query-related features. Typical LMMs are configured to equally tend to all the input tokens whether coming from an image or a query. Instead, the attention modulation 608 prioritizes the tokens related to the ROI.

As a particular illustrative example, let Q, K, V be B×T×Ch query, key, and value tensors, respectively, belonging to each token input to the language model, where B is the batch size, T is the number of tokens input to the language model, and Ch is the feature dimension. In this example, A is a new attention token of size B×T×T, \sqrt{dₖ} is a normalization factor for controlling variance, × denotes batch matrix multiplication and ⊙ denotes element wise multiplication. A typical self-attention mechanism

$$softmax ( \frac{Q \times {K}^{⊤}}{\sqrt{{d}_{k}}} ) \times V$$

in a language model tends equally to all the non-padding tokens by computing a weighted average of all the value tensors V with weights given by

$$softmax ( \frac{Q \times {K}^{⊤}}{\sqrt{{d}_{k}}} ) .$$

To give more attention to the ROI-related tokens (e.g., the ROI feature data 518), the above self-attention mechanism is modified by introducing a new attention tensor A as follows:

$$softmax ( A ⊙ \frac{Q \times {K}^{⊤}}{\sqrt{{d}_{k}}} ) \times V$$

For a given batch, each cell (i,j) in A denotes how much weightage does token i give to token j. Therefore in A, a) for all i belonging to padding tokens, the corresponding cells are registered as −inf (e.g., a null or negative value); b) each cell (i,j) where i belongs to a token from the query and j belongs to an ROI-related token, the cell is registered as z>0, where z is a hyperparameter (e.g., a value of the hyperparameters 618); and c.) all other cells are registered as 0 (e.g., a default or particular value). The value of z may be set based on the desired weighting, with larger values indicating more weighting. In some embodiments, the value of z may be based on a user input or an input from another device or an application executed by the device. Using the attention tensor A (e.g., the hyperparameters 618), padding tokens are assigned a null or negative weight and ROI-related tokens are assigned higher weights than non-ROI-related tokens, with the weights being summed to one due to the softmax operator.

FIG. 7 is a diagram of an example of a method of ROI enhancement to enable ROI processing by a trained model at inference-time, in accordance with some aspects of the present disclosure. The method 700 of FIG. 7 may be performed by a device that is configured to enable ROI processing by a trained model at inference-time, or components thereof. For example, one or more operations of the method 700 may be performed by the ROI engine 124, the ROI injector 144, the processor 108, the device 102, the system 100 of FIG. 1, the ROI injector 214, the ROI enhancer 216 of FIG. 2, another device or processor, or a combination thereof. For ease of description, actions are described below with reference to the ROI injector 144 of the ROI engine 124 of FIG. 1. Performance of the method 700 may generate an enhanced ROI extracted from an input image with minimal (or no) resampling artifacts while preserving the aspect ratio of the ROI.

The method 700 includes, at 702, determining a width and a height of a ROI in an image with respect to a model input image size, such as dimension parameters or size and aspect ratio parameters, as described above. For example, the ROI detector 122 of FIG. 1 or the ROI detector 202 of FIG. 2 may determine a ROI within an image of the image data 113 or the image data 230, respectively. In a particular example, an image (I_{H,W}) to be processed by a multimodal model has a height H and a width W, dimension criteria of inputs to the multimodal model may specify that input images have a height ph and a width pw, and a bounding box of the ROI is defined by a point having coordinates (x, y), a width width, and a height height. A straightforward solution of cropping the ROI having the size width×height and resizing to the size pw×ph is susceptible to introducing significant numbers of resampling artifacts. However, such resampling artifacts may reduce the accuracy of answers generated by the multimodal model.

To avoid introducing these resampling artifacts, the method 700 includes, at 704, determining whether the boundaries satisfy a first threshold (e.g., whether width<pw/2 and whether height<ph/2). If the boundaries satisfy the first threshold (e.g., if width<pw/2 and height<ph/2), the method 700 continues to 706, and a patch (e.g., an ROI patch area) within the image that includes the ROI is determined and cropped from the image, and one or more upscaling operations are performed to increase a size of the patch based on the size criterion of the multimodal model (e.g., an image encoding and mapping model). For example, the ROI injector 144 of FIG. 1, the ROI injector 214, or the ROI enhancer 216 of FIG. 2 may crop an ROI patch area that includes the ROI and that has the size pw/2×ph/2 from the image, and the cropped ROI patch may be resized to the size pw×ph. Because the dimensions of the ROI patch area are multiples of the dimension criteria, this cropping and resizing (e.g., one or more upscaling operations) preserves the aspect ratio of the ROI patch as well as focusing (e.g., zooming in) on the ROI in a manner that improves the accuracy of the multimodal model as compared to not receiving ROI-related input. The resized patch is represented by model input data (e.g., the ROI image data 512 of FIG. 5) that is provided to the multimodal modal for image encoding and mapping (e.g., after performance of the one or more upscaling operations).

If the boundaries fail to satisfy the first threshold, the method 700 includes, at 708, determining whether the boundaries satisfy a second threshold (e.g., whether pw/2<width<pw and whether ph/2<height<ph). If the boundaries satisfy the second threshold (e.g., if pw/2<width<pw and if ph/2<height<ph), the method 700 continues to 710, and a patch within the image that includes the ROI is determined and cropped from the image (e.g., without resizing or rescaling). For example, the ROI injector 144, the ROI injector 214, or the ROI enhancer 216 may crop an ROI patch area that includes the ROI and that has the size pw×ph from the image. Because the dimensions of the ROI patch area are the same as the dimension criteria, no resizing is performed, and thus the aspect ratio of the ROI does not change. The cropped patch is represented by the model input data (e.g., the ROI image data 512) that is provided to the multimodal modal for image encoding and mapping (e.g., after the cropping operation).

If the boundaries fail to satisfy the second threshold, the method 700 includes, at 712, determining whether the boundaries satisfy a third threshold (e.g., whether width>pw or whether height>ph). If the boundaries satisfy the third threshold (e.g., if width>pw, if height>ph, or both), the method 700 continues to 714, and one or more downscaling operations are performed to decrease a size of the image based on the size criterion of the multimodal model, and a patch (e.g., an ROI patch area) within the downscaled image that includes the ROI is determined and cropped from the image. For example, the ROI injector 144, the ROI injector 214, or the ROI enhancer 216 may resize the image by a sampling coefficient=minimum (pw/width, ph/height), and after resizing (e.g., downscaling) the image, an ROI patch area that includes the ROI and that has the size width×height is cropped from the image. Because the sampling coefficient is selected to preserve the aspect ratio of the ROI within the image while also ensuring that the ROI is within the size criteria, the cropped ROI patch focuses (e.g., zooms in) on the ROI in a manner that preserves the aspect ratio and that improves the accuracy of the multimodal model as compared to not receiving ROI-related input. The patch is represented by model input data (e.g., the ROI image data 512) that is provided to the multimodal modal for image encoding and mapping (e.g., after performance of the one or more downscaling and cropping operations).

If the boundaries fail to satisfy the third threshold, the method 700 includes, at 716, determining and cropping a patch (e.g., an ROI patch area) from within the image that has a particular minimum size and that includes the ROI, and performing one or more upscaling operations to increase a size of the particularly-sized patch based on the size criterion of the multimodal model. For example, the ROI injector 144, the ROI injector 214, or the ROI enhancer 216 may crop an ROI patch area that includes the ROI and that has a minimum size W/k×H/k from the image, and the cropped ROI patch may be resized to the size pw×ph. In this example, k is a preset value that can be based on a target maximum upscaling coefficient. In some embodiments, k is four. Because k is selected to balance between reducing the amount of upscaling performed and to ensure the ROI patch has sufficient information to provide to the multimodal model, this resizing (e.g., one or more upscaling operations) and cropping represents a compromise between maintaining the aspect ratio of the ROI and reducing resampling artifacts. The resized patch is represented by model input data (e.g., the ROI image data 512) that is provided to the multimodal modal for image encoding and mapping (e.g., after performance of the cropping and one or more upscaling operations).

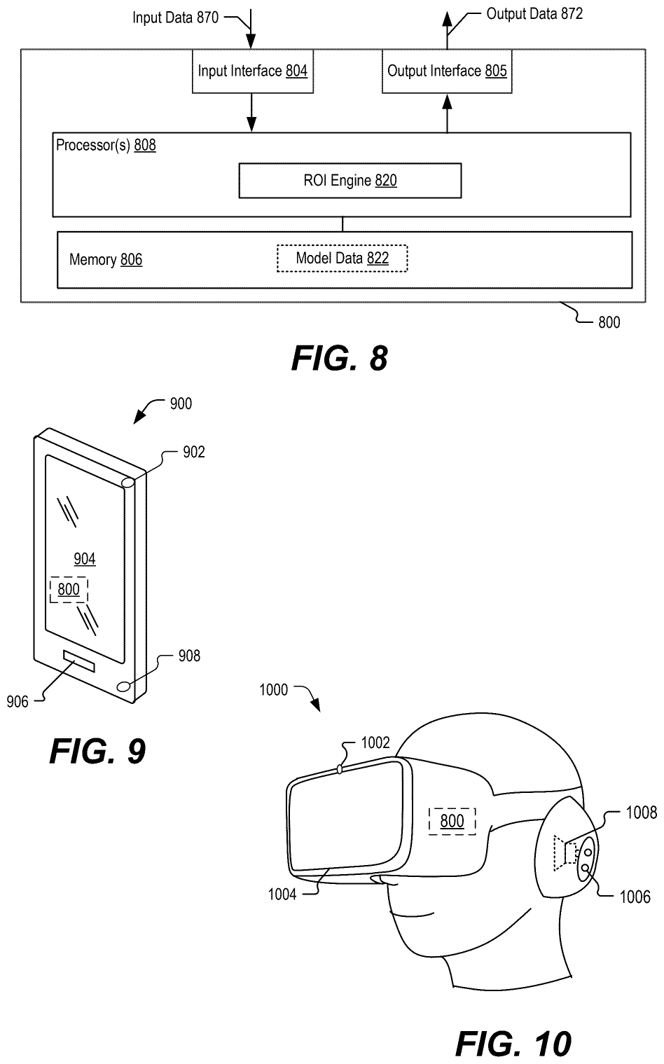

FIG. 8 depicts a diagram of an example of an integrated circuit 800 operable to enable ROI processing by a trained model at inference-time, in accordance with some examples of the present disclosure. The integrated circuit 800 includes one or more processors 808 (herein after referred to as the “processor 808”) and a memory 806. The processor 808 and the memory 806 may include or correspond to the processor 108 and the memory 106, respectively. The processor 808 may include an ROI engine 820. The ROI engine 820 may include or correspond to the ROI engine 124, one or more of the components 200, or a combination thereof. In some examples, the memory 806 includes (e.g., stores) model data 822, which may include or correspond to the model data 130, and the processor 808 is configured to implement the multimodal model 126, the pretrained multimodal model 220, or the pretrained multimodal model 300. Alternatively, output generated by the ROI engine 820 may be provided to another device or component that implements a multimodal model. Additionally, or alternatively, the processor 808 may include the model input generator 120, the ROI detector 122, one or more of the components 200, or a combination thereof (not shown), in examples in which the integrated circuit 800 is configured to generate model input data or to detect an ROI in image data.

The integrated circuit 800 also includes an input interface 804, such as one or more bus interfaces, to enable the integrated circuit 800 to receive input data 870 for processing. For example, the input data 870 can correspond to or include the sensor data 111, the image data 113, the input data 115, the model input data 132, the boundary data 134, the image data 230, the input data 232, the boundary data 234, the tile data 236, the context image data 244, the query text data 246, the modified model input data 310, the image data 410, the formatted image data 412, the tile data 414, the boundary data 416, the context image data 510, the text data 610, or a combination thereof. The integrated circuit 800 also includes an output interface 805, such as a bus interface, to enable the integrated circuit 800 to generate output data 872. For example, the output data 872 can correspond to or include the modified model input data 136, the ROI-aware tile data 142, the ROI feature data 146, the hyperparameters 150, the response output 138, the ROI text data 238, the ROI-aware tile data 240, the ROI image data 242, the hyperparameters 248, the response output 250, the response output 316, the ROI-aware tile data 418, the ROI image data 512, the hyperparameters 618, or a combination thereof.

The integrated circuit 800 including the ROI engine 820 enables implementation of ROI processing by a trained model at inference-time as a component in a system or a device. For example, the system or the device may include a mobile device (e.g., a mobile phone or tablet) as depicted in FIG. 9, a wearable electronic device as depicted in FIG. 11, a voice-controlled speaker system as depicted in FIG. 12, a camera as depicted in FIG. 13, a virtual reality, mixed reality, or augmented reality headset as depicted in FIG. 10, or a vehicle as depicted in FIG. 14.

In some embodiments, the system or the device that includes the integrated circuit 800 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 112, the input device 114, the display device 116, the speaker 117, and the modem 118, respectively.

FIG. 9 depicts a diagram of a mobile device 900 operable to enable ROI processing by a trained model at inference-time, in accordance with some examples of the present disclosure. The mobile device 900 may include or correspond to a phone or a tablet, as illustrative, non-limiting examples. The mobile device 900 includes a camera 902 (e.g., an image sensor), a display 904 (e.g., a display screen), a microphone 906, a speaker 908, and the integrated circuit 800. Components of the integrated circuit 800, including the ROI engine 820, are integrated in the mobile device 900 and are illustrated using dashed lines to indicate internal components that are not generally visible to a user of the mobile device 900.

In a particular example, the ROI engine 820 is operable to obtain image data representing images or video captured by the camera 902, from another device, or from an application executed by the mobile device 900, to generate model input data for a trained model, and to selectively modify the model input data based on boundaries of a ROI within an image represented by the image data. Selectively modifying the model input data to include ROI-related data enables the mobile device 900 to support ROI processing by the trained model at inference-time.

FIG. 10 is a diagram of a headset 1000, such as a virtual reality, mixed reality, or augmented reality headset, operable to enable ROI processing by a trained model at inference-time, in accordance with some examples of the present disclosure. A visual interface device is positioned in front of the user's eyes to enable display of augmented reality, mixed reality, or virtual reality images or scenes to the user while the headset 1000 is worn. The headset 1000 also includes a camera 1002 (e.g., an image sensor), a display 1004 (e.g., a display screen), a microphone 1006, a speaker 1008, and the integrated circuit 800. Components of the integrated circuit 800, including the ROI engine 820, are integrated in the headset 1000 and are illustrated using dashed lines to indicate internal components that are not generally visible to a user of the headset 1000.

In a particular example, the ROI engine 820 is operable to obtain image data representing images or video captured by the camera 1002, from another device, or from an application executed by the headset 1000, to generate model input data for a trained model, and to selectively modify the model input data based on boundaries of a ROI within an image represented by the image data. Selectively modifying the model input data to include ROI-related data enables the headset 1000 to support ROI processing by the trained model at inference-time.

FIG. 11 depicts a diagram of a wearable electronic device 1100 operable to enable ROI processing by a trained model at inference-time, in accordance with some examples of the present disclosure. The wearable electronic device 1100 may include or correspond to a “smart watch,” as an illustrative, non-limiting example. The wearable electronic device 1100 includes a camera 1102 (e.g., an image sensor), a display 1104 (e.g., a display screen), a microphone 1106, a speaker 1108, and the integrated circuit 800. Components of the integrated circuit 800, including ROI engine 820, is integrated in the wearable electronic device 1100 and are illustrated using dashed lines to indicate internal components that are not generally visible to a user of the wearable electronic device 1100.

In a particular example, the ROI engine 820 is operable to obtain image data representing images or video captured by the camera 1102, from another device, or from an application executed by the wearable electronic device 1100, to generate model input data for a trained model, and to selectively modify the model input data based on boundaries of a ROI within an image represented by the image data. Selectively modifying the model input data to include ROI-related data enables the wearable electronic device 1100 to support ROI processing by the trained model at inference-time.

FIG. 12 is a diagram of a voice-controlled speaker system 1200 operable to enable ROI processing by a trained model at inference-time, in accordance with some examples of the present disclosure. The voice-controlled speaker system 1200 may include or correspond to a wireless speaker and voice activated device, as an illustrative, non-limiting example. The voice-controlled speaker system 1200 can have wireless network connectivity and is configured to execute an assistant operation. The voice-controlled speaker system 1200 includes a camera 1202 (e.g., an image sensor), a display 1204 (e.g., a display screen), a microphone 1206, a speaker 1208, and the integrated circuit 800. Components of the integrated circuit 800, including the ROI engine 820, are integrated in the voice-controlled speaker system 1200 and are illustrated using dashed lines to indicate internal components that are not generally visible to a user of the voice-controlled speaker system 1200.

In a particular example, the ROI engine 820 is operable to obtain image data representing images or video captured by the camera 1202, from another device, or from an application executed by the voice-controlled speaker system 1200, to generate model input data for a trained model, and to selectively modify the model input data based on boundaries of a ROI within an image represented by the image data. Selectively modifying the model input data to include ROI-related data enables the voice-controlled speaker system 1200 to support ROI processing by the trained model at inference-time.

FIG. 13 is a diagram of a camera device 1300 operable to enable ROI processing by a trained model at inference-time, in accordance with some examples of the present disclosure. The camera device 1300 includes an image sensor 1302, a display 1304 (e.g., a display screen), a microphone 1306, a speaker 1308, and the integrated circuit 800. Components of the integrated circuit 800, including the ROI engine 820, are integrated in the camera device 1300 and are illustrated using dashed lines to indicate internal components that are not generally visible to a user of the camera device 1300.

In a particular example, the ROI engine 820 is operable to obtain image data representing images or video captured by the image sensor 1302, from another device, or from an application executed by the camera device 1300, to generate model input data for a trained model, and to selectively modify the model input data based on boundaries of a ROI within an image represented by the image data. Selectively modifying the model input data to include ROI-related data enables the camera device 1300 to support ROI processing by the trained model at inference-time.

FIG. 14 is a diagram of an example of a vehicle 1400 operable to enable ROI processing by a trained model at inference-time, in accordance with some examples of the present disclosure. The vehicle 1400 may include or correspond to a car. The vehicle 1400 includes a camera 1402 (e.g., an image sensor), a display 1404 (e.g., a display screen), a microphone 1406, one or more speakers 1408, and the integrated circuit 800. Components of the integrated circuit 800, including the ROI engine 820, are integrated in the vehicle 1400 and are illustrated using dashed lines to indicate internal components that are not generally visible to a user of the vehicle 1400.

In a particular example, the ROI engine 820 is operable to obtain image data representing images or video captured by the camera 1402, from another device, or from an application executed by the vehicle 1400, to generate model input data for a trained model, and to selectively modify the model input data based on boundaries of a ROI within an image represented by the image data. Selectively modifying the model input data to include ROI-related data enables the vehicle 1400 to support ROI processing by the trained model at inference-time.

The embodiments of the systems or devices as described with reference to FIGS. 9-14 are described, respectively, as including a display, a microphone, a speaker, a camera, or a combination thereof. As described with reference to FIGS. 9-14, the display, the microphone, the speaker, the camera may include or correspond to the display device 116, the input device 114, the speaker 117, and the image sensor 112, respectively. It is noted that in other embodiments of the systems or devices of FIGS. 9-14, one or more of the systems or devices of FIGS. 9-14 may not include the display, the microphone, the speaker, the camera, or a combination thereof. Additionally, or alternatively, one or more of the systems or devices of FIGS. 9-14 may include an additional component. For example, the additional component may include a modem, such as the modem 118, or a sensor, such as the sensor 110.

FIG. 15 is a diagram of an example of a method 1500 of enabling ROI processing by a trained model at inference-time, in accordance with some aspects of the present disclosure. In a particular aspect, one or more operations of the method 1500 are performed by the system 100, the device 102, the processor 108, the model input generator 120, the ROI detector 122, the ROI engine 124, the multimodal model 126, the components 200, the pretrained multimodal model 300, the integrated circuit 800, the ROI engine 820, the mobile device 900, the headset 1000, the wearable electronic device 1100, the voice-controlled speaker system 1200, the camera device 1300, the vehicle 1400, or a combination thereof.

In some embodiments, the method 1500 includes, at block 1502, obtaining image data representing an image. For example, the model input generator 120 may obtain the image data 113 that represents an image. The method 1500 also includes, at block 1504, obtaining data representing a ROI within the image. For example, the model input generator 120 (and optionally the ROI detector 122) may obtain the input data 115 that indicates an ROI within the image, the ROI detector 122 may obtain the sensor data 111 that represents the ROI. In some embodiments, the input data 115 also indicates a query, and the model input generator 120 obtains the input data 115 that represents the query.

The method 1500 further includes, at block 1506, determining boundaries of the ROI within the image based on the data. For example, the ROI detector 122 may determine the boundary data 134 that represents the boundaries of the ROI within the image. The method 1500 includes, at block 1508, generating model input data based on the image data and the data. For example, the model input generator 120 may generate the model input data 132 based on the image data 113 and the input data 115 (and optionally the sensor data 111).

The method 1500 includes, at block 1510, selectively modifying the model input data based on the boundaries. For example, the ROI engine 124 may selectively modify the model input data 132 based on the boundary data 134 to generate the modified model input data 136. The method 1500 includes, at block 1512, providing the model input data as input to a trained multimodal model to generate a response output. For example, the multimodal model 126 may generate the response output 138 based on the modified model input data 136. The response output 138 may be an answer to the query (e.g., a question from a user). In some embodiments, the trained multimodal model includes an image encoding and mapping model, a text encoding model, and a language model. In such embodiments, the image encoding and mapping model is configured to generate first feature data based on the model input data, the text encoding model is configured to generate second feature data based on the model input data, and the language model is configured to generate the response output based on the first feature data and the second feature data. For example, the image encoding and mapping model may include or correspond to the image encoder 302 and the mapper 304, the text encoding model may include or correspond to the text tokenizer 306, and the language model may include or correspond to the language model 308.

In some embodiments, the method 1500 includes determining whether the boundaries satisfy one or more thresholds and modifying the model input data prior to providing the model input data as the input to the trained multimodal model based on the boundaries satisfying the one or more thresholds. For example, the ROI engine 124 may determine whether the boundaries represented by the boundary data 134 satisfy one or more thresholds, and if the one or more thresholds are satisfied, the ROI engine 124 may modify the model input data 132 to generate the modified model input data 136. Alternatively, the method 1500 may include determining whether the boundaries satisfy one or more thresholds and providing the model input data as the input to the trained multimodal model without modification based on the boundaries failing to satisfy the one or more thresholds. For example, if the one or more thresholds are not satisfied, the ROI engine 124 may pass the model input data 132 without modification as input to the multimodal model 126.

In some embodiments, the method 1500 includes dividing the image into a set of tiles, where the model input data represents the set of tiles and each tile of the set of tiles has a corresponding size that is based on a size criterion associated with an image encoding and mapping model. For example, the model input generator 120 may divide the image represented by the image data 113 into tiles that each have a corresponding size that is based on a size criterion associated with an image and encoding model. In some such embodiments, the method 1500 also includes determining, based on the boundaries, whether the ROI extends across multiple tiles of the set of tiles. In such embodiments, the model input data is modified based on the ROI extending across the multiple tiles. For example, the ROI-aware tile adjuster 140 may modify the tile data represented by the model input data 132 based on the ROI extending across multiple tiles to generate the ROI-aware tile data 142 that is included in the modified model input data 136. In some such embodiments, the method 1500 also includes modifying a size of a first tile of the multiple tiles such that, after modification of the size, the first tile includes an entirety of the ROI, and modifying a size of a first tile of the multiple tiles such that, after modification of the size, the first tile includes an entirety of the ROI, as further described herein with reference to FIG. 4.

In some embodiments, prior to modification of the model input data, the model input data represents the image and the query. For example, the model input data 132 may represent the image (e.g., a context image) and the query that is represented by the input data 115. Optionally, the model input data 132 may also include a set of tiles generated from the image. In some such embodiments, the method 1500 includes determining whether the boundaries satisfy one or more thresholds, where, after modification of the model input data, the model input data further represents the ROI based on the boundaries satisfying the one or more thresholds. For example, the ROI injector 144 may generate the ROI feature data 146 that is included in the modified model input data 136 based on the boundaries satisfying one or more thresholds.

In some such embodiments in which the method 1500 includes determining whether the boundaries satisfy the one or more thresholds, the method 1500 also includes determining whether the boundaries satisfy a first threshold of the one or more thresholds, in addition to determining, based on the boundaries satisfying the first threshold, a patch within the image that includes the ROI and performing one or more upscaling operations to increase a size of the patch based on a size criterion of an image encoding and mapping model. The one or more upscaling operations preserve an aspect ratio of the patch, and the model input data represents the patch after performance of the one or more upscaling operations. For example, the ROI injector 144 may generate the ROI feature data 146 to represent a ROI patch that is cropped and upscaled, based on the first threshold being satisfied, as further described herein with reference to FIGS. 5 and 7.

In some embodiments in which the method 1500 includes determining whether the boundaries satisfy the one or more thresholds, the method 1500 also includes determining whether the boundaries satisfy a second threshold of the one or more thresholds and determining, based on the boundaries satisfying the second threshold, a patch within the image that includes the ROI. The model input data represents the patch. For example, the ROI injector 144 may generate the ROI feature data 146 to represent a ROI patch that is cropped and not further scaled, based on the second threshold being satisfied, as further described herein with reference to FIGS. 5 and 7. Additionally, or alternatively, the method 1500 also includes determining whether the boundaries satisfy a third threshold of the one or more thresholds and performing, based on the boundaries satisfying the third threshold, one or more downscaling operations to decrease a size of the image based on a size criterion of an image encoding and mapping model. The method 1500 also includes determining a patch within the image that includes the ROI. The model input data represents the patch after performance of the one or more downscaling operations. For example, the ROI injector 144 may generate the ROI feature data 146 to represent a ROI patch that is downscaled and then cropped, based on the third threshold being satisfied, as further described herein with reference to FIGS. 5 and 7.

In some embodiments, the method 1500 also includes obtaining one or more hyperparameter values of the trained multimodal model. The one or more hyperparameter values are indicative of a relative weighting of features associated with the ROI relative to features of the image for areas outside the ROI. For example, the attention modulator 148 may generate the hyperparameters 150 that indicate a relative weighting of features associated with the ROI relative to features of the image for areas outside the ROI, as further described herein with reference to FIG. 6.

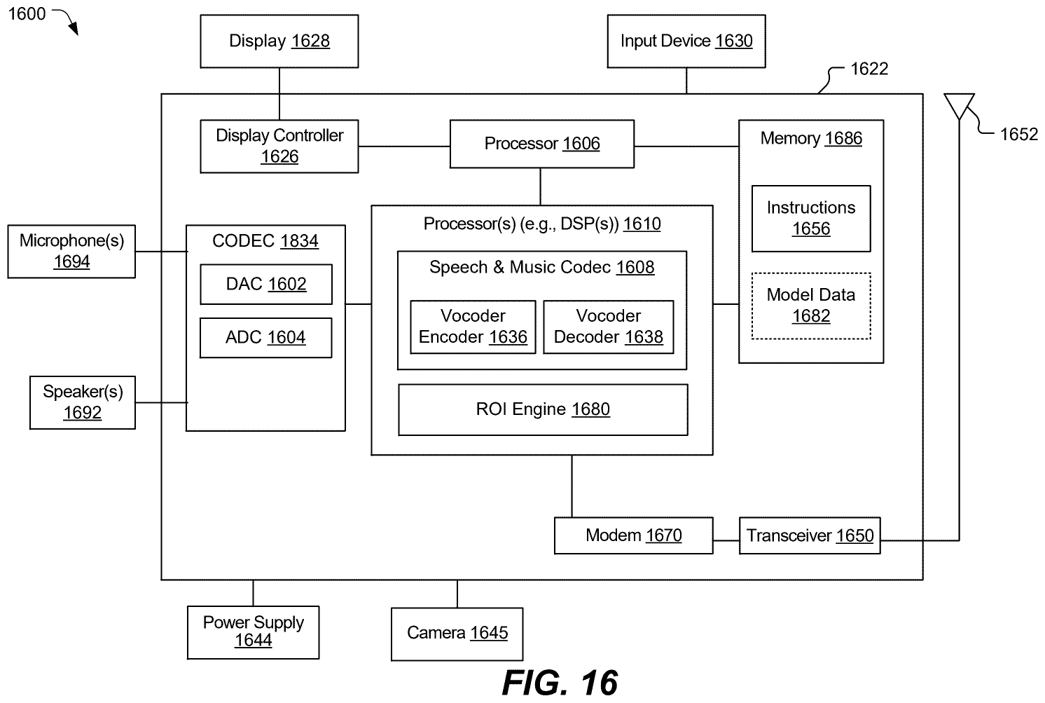

The method 1500 of FIG. 15 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1500 of FIG. 15 may be performed by a processor that executes instructions, such as described with reference to FIG. 16.

It is noted that one or more blocks (or operations) described with reference to FIG. 15 may be combined with one or more blocks (or operations) described with reference to another of the figures. For example, one or more blocks associated with FIG. 15 may be combined with one or more blocks (or operations) associated with FIGS. 1-14. Additionally, or alternatively, one or more operations described above with reference to FIGS. 1-15 may be combined with one or more operations described with reference to FIG. 16.

FIG. 16 is a block diagram of an illustrative example of a device 1600 that is operable to enable ROI processing by a trained model at inference-time, in accordance with one or more aspects of the present disclosure. In various implementations, the device 1600 may have more or fewer components than illustrated in FIG. 16. In an illustrative implementation, the device 1600 may correspond to the device 102. In an illustrative implementation, the device 1600 may perform one or more operations described with reference to FIGS. 1-15.

In a particular implementation, the device 1600 includes a processor 1606 (e.g., a central processing unit (CPU)). The device 1600 may include one or more additional processors 1610 (e.g., one or more DSPs). In a particular aspect, the processor 108 of FIG. 1 or the processor 808 of FIG. 8 corresponds to the processor 1606, the processor(s) 1610, or a combination thereof. The processor(s) 1610 may include a speech and music coder-decoder (CODEC) 1608 that includes a voice coder (“vocoder”) encoder 1636, a vocoder decoder 1638, an ROI engine 1680, or a combination thereof. The ROI engine 1680 may include or correspond to the ROI engine 124, one or more of the components 200, the ROI engine 820, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1600 may include a memory 1686 and a CODEC 1634. The memory 1686 may include or correspond to the memory 106 or the memory 806. The memory 1686 may include instructions 1656, that are executable by the one or more additional processors 1610 (or the processor 1606) to implement the functionality described with reference to the ROI engine 1680, or both. The instructions 1656 may include or correspond to the instructions 109. The memory 1686 optionally includes model data 1682. The model data 1682 may include or correspond to the model data 130 or the model data 822, and the model data 1682 may be used to implement the multimodal model 126, the pretrained multimodal model 220, or the pretrained multimodal model 300. The device 1600 may include a modem 1670 coupled, via a transceiver 1650, to an antenna 1652.

The device 1600 may include a display 1628 coupled to a display controller 1626. One or more speakers 1692, the microphone(s) 1694 may be coupled to the CODEC 1634. The CODEC 1634 may include a digital-to-analog converter (DAC) 1602, an analog-to-digital converter (ADC) 1604, or both. In a particular implementation, the CODEC 1634 may receive analog signals from the microphone(s) 1694, convert the analog signals to digital signals using the ADC 1604, and provide the digital signals to the speech and music codec 1608. The speech and music codec 1608 may process the digital signals, and the digital signals may further be processed by the ROI engine 1680. In a particular implementation, the speech and music codec 1608 may provide digital signals to the CODEC 1634. The CODEC 1634 may convert the digital signals to analog signals using the DAC 1602 and may provide the analog signals to the speaker(s) 1692.

In a particular implementation, the device 1600 may be included in a system-in-package or system-on-chip device 1622. In a particular implementation, the memory 1686, the processor 1606, the processor(s) 1610, the display controller 1626, the CODEC 1634, and the modem 1670 are included in the system-in-package or system-on-chip device 1622. In a particular implementation, an input device 1630, a power supply 1644, and a camera 1645 are coupled to the system-in-package or the system-on-chip device 1622. For example, the input device 1630 and the camera 1645 may include or correspond to the input device 114 and the image sensor 112, respectively. In some examples, the input device 1630 may include or be associated with the display device 116 or the display 1628. Moreover, in a particular implementation, as illustrated in FIG. 16, the display 1628, the input device 1630, the speaker(s) 1692, the microphone(s) 1694, the antenna 1652, the power supply 1644, and the camera 1645 are external to the system-in-package or the system-on-chip device 1622. In a particular implementation, each of the display 1628, the input device 1630, the speaker(s) 1692, the microphone(s) 1694, the antenna 1652, the power supply 1644, and the camera 1645 may be coupled to a component of the system-in-package or the system-on-chip device 1622, such as an interface or a controller.

The device 1600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining image data representing an image. For example, the means for obtaining the image data can include the image sensor 112, the model input generator 120, the processor 108, the device 102, the ROI detector 202, the tiled images extractor 206, the context image extractor 208, the ROI injector 214, the components 200, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to obtain image data, or a combination thereof.

The apparatus also includes means for obtaining data representing a ROI within the image. For example, the means for obtaining the data can include the sensor 110, the image sensor 112, the input device 114, the model input generator 120, the ROI detector 122, the processor 108, the device 102, the ROI detector 202, the tiled images extractor 206, the context image extractor 208, the ROI injector 214, the components 200, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to obtain data representing a ROI within an image, or a combination thereof.

The apparatus also includes means for determining boundaries of the ROI within the image based on the data. For example, the means for determining can include the ROI detector 122, the processor 108, the device 102, the ROI detector 202, the components 200, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to determine boundaries of an ROI within an image, or a combination thereof.

The apparatus also includes means for generating model input data based on the image data and the data. For example, the means for generating can include the model input generator 120, the processor 108, the device 102, the tiled images extractor 206, the context image extractor 208, the input processor 210, the components 200, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to generate model input data, or a combination thereof.

The apparatus also includes means for selectively modifying the model input data based on the boundaries. For example, the means for selectively modifying can include the ROI engine 124, the ROI-aware tile adjuster 140, the ROI injector 144, the attention modulator 148, the processor 108, the device 102, the OCR module 204, the ROI-aware tile adjuster 212, the ROI injector 214, the ROI enhancer 216, the attention modulator 218, the components 200, the integrated circuit 800, the ROI engine 820, the mobile device 900, the headset 1000, the wearable electronic device 1100, the voice-controlled speaker system 1200, the camera device 1300, the vehicle 1400, the ROI engine 1680, the processor 1606, the processor(s) 1610, the system-in-package or the system-on-chip device 1622, the device 1600, other circuitry configured to selectively modify model input data based on boundaries of a ROI, or a combination thereof.

The apparatus also includes means for providing the model input data as input to a trained multimodal model to generate a response output. For example, the means for providing can include the ROI engine 124, the processor 108, the device 102, the OCR module 204, the ROI-aware tile adjuster 212, the ROI injector 214, the ROI enhancer 216, the attention modulator 218, the components 200, the integrated circuit 800, the ROI engine 820, the mobile device 900, the headset 1000, the wearable electronic device 1100, the voice-controlled speaker system 1200, the camera device 1300, the vehicle 1400, the ROI engine 1680, the processor 1606, the processor(s) 1610, the system-in-package or the system-on-chip device 1622, the device 1600, other circuitry configured to provide model input data (after selective modification) as input to a trained multimodal model, or a combination thereof.

In some implementations, a non-transitory computer-readable medium (e.g., a computer-readable storage device, such as the memory 106 or the memory 1686) includes instructions (e.g., the instructions 109 or the instructions 1656) that, when executed by one or more processors (e.g., the processor 108, the processor(s) 1610, or the processor 1606), cause the one or more processors to obtain image data (e.g., the image data 113) representing an image. The instructions, when executed by the one or more processors, also cause the one or more processors to obtain data (e.g., the input data 115 and optionally, the sensor data 111) representing a ROI within the image. The instructions, when executed by the one or more processors, also cause the one or more processors to determine boundaries (e.g., represented by the boundary data 134) of the ROI within the image based on the data. The instructions, when executed by the one or more processors, also cause the one or more processors to generate model input data (e.g., the model input data 132) based on the image data and the data. The instructions, when executed by the one or more processors, also cause the one or more processors to selectively modify the model input data (e.g., to generate the modified model input data 136) based on the boundaries. The instructions, when executed by the one or more processors, also cause the one or more processors to provide the model input data as input to a trained multimodal model (e.g., the multimodal model 126) to generate a response output (e.g., the response output 138).

Particular aspects of the disclosure are described below in sets of interrelated Examples:

According to Example 1, a device includes: a memory configured to store model data associated with a trained multimodal model; and one or more processors coupled to the memory, wherein the one or more processors are configured to obtain image data representing an image; obtain data representing a region of interest (ROI) within the image; determine boundaries of the ROI within the image based on the data; generate model input data based on the image data and the data; selectively modify the model input data based on the boundaries; and provide the model input data as input to the trained multimodal model to generate a response output associated.

Example 2 includes the device of Example 1, wherein the one or more processors are configured to divide the image into a set of tiles, wherein the model input data represents the set of tiles, and wherein each tile of the set of tiles has a corresponding size that is based on a size criterion associated with an image encoding and mapping model.

Example 3 includes the device of Example 2, wherein the one or more processors are configured to determine, based on the boundaries, whether the ROI extends across multiple tiles of the set of tiles, wherein the model input data is modified based on the ROI extending across the multiple tiles.

Example 4 includes the device of Example 3, wherein the one or more processors are configured to, based on the ROI extending across the multiple tiles: modify a size of a first tile of the multiple tiles such that, after modification of the size, the first tile includes an entirety of the ROI; and for each tile of one or more other tiles included in the multiple tiles, modify a size of the tile such that the ROI is not included in the tile.

Example 5 includes the device of any of Examples 1 to 4, wherein, prior to modification of the model input data, the model input data represents the image and a query associated with the image.

Example 6 includes the device of Example 5, wherein the one or more processors are configured to determine whether the boundaries satisfy one or more thresholds, wherein, after modification of the model input data, the model input data further represents the ROI based on the boundaries satisfying the one or more thresholds.

Example 7 includes the device of Example 6, wherein the one or more processors are configured to: determine whether the boundaries satisfy a first threshold of the one or more thresholds; determine, based on the boundaries satisfying the first threshold, a patch within the image that includes the ROI; and perform one or more upscaling operations to increase a size of the patch based on a size criterion of an image encoding and mapping model, wherein the one or more upscaling operations preserve an aspect ratio of the patch, and wherein the model input data represents the patch after performance of the one or more upscaling operations.

Example 8 includes the device of Example 6, wherein the one or more processors are configured to: determine whether the boundaries satisfy a second threshold of the one or more thresholds; and determine, based on the boundaries satisfying the second threshold, a patch within the image that includes the ROI, wherein the model input data represents the patch.

Example 9 includes the device of Example 6, wherein the one or more processors are configured to: determine whether the boundaries satisfy a third threshold of the one or more thresholds; perform, based on the boundaries satisfying the third threshold, one or more downscaling operations to decrease a size of the image based on a size criterion of an image encoding and mapping model; and determine a patch within the image that includes the ROI, wherein the model input data represents the patch after performance of the one or more downscaling operations.

Example 10 includes the device of any of Examples 1 to 9, wherein the one or more processors are configured to obtain one or more hyperparameter values of the trained multimodal model, wherein the one or more hyperparameter values are indicative of a relative weighting of features associated with the ROI relative to features of the image for areas outside the ROI.

Example 11 includes the device of any of Examples 1 to 10, wherein: the trained multimodal model includes an image encoding and mapping model, a text encoding model, and a language model; the image encoding and mapping model is configured to generate first feature data based on the model input data; the text encoding model is configured to generate second feature data based on the model input data; and the language model is configured to generate the response output based on the first feature data and the second feature data.

Example 12 includes the device of any of Examples 1 to 11, and further includes a modem coupled to the one or more processors and configured to receive the image data, the data representing the ROI, or a combination thereof.

Example 13 includes the device of any of Examples 1 to 12, and further includes one or more cameras coupled to the one or more processors and configured to generate the image data.

Example 14 includes the device of any of Examples 1 to 13, and further includes one or more microphones configured to generate audio data representing user speech, wherein the data representing the ROI includes the audio data.

Example 15 includes the device of any of Examples 1 to 14, and further includes a user interface configured to generate text data based on user input, wherein the data representing the ROI includes the text data.

Example 16 includes the device of any of Examples 1 to 15, wherein the one or more processors are included in an integrated circuit.

Example 17 includes the device of any of Examples 1 to 16, wherein the one or more processors are integrated in at least one of a mobile phone, a tablet computer device, a wearable electronic device, an extended reality (XR) device, or a camera device, and wherein the mobile phone, the tablet computer device, the wearable electronic device, the XR device, or the camera device is configured to output the response output.

Example 18 includes the device of any of Examples 1 to 16, wherein the one or more processors are integrated in a vehicle that is configured to output the response output.

According to Example 19, a method includes: obtaining, by one or more processors, image data representing an image; obtaining, by the one or more processors, data representing a region of interest (ROI) within the image; determining, by the one or more processors, boundaries of the ROI within the image based on the data; generating, by the one or more processors, model input data based on the image data and the data; selectively modifying, by the one or more processors, the model input data based on the boundaries; and providing, by the one or more processors, the model input data as input to a trained multimodal model to generate a response output.

Example 20 includes the method of Example 19, wherein selectively modifying the model input data includes: determining whether the boundaries satisfy one or more thresholds; and modifying the model input data prior to providing the model input data as the input to the trained multimodal model based on the boundaries satisfying the one or more thresholds.

Example 21 includes the method of Example 19, wherein selectively modifying the model input data includes: determining whether the boundaries satisfy one or more thresholds; and providing the model input data as the input to the trained multimodal model without modification based on the boundaries failing to satisfy the one or more thresholds.

Example 22 includes the method of any of Examples 19 to 21, and further includes dividing the image into a set of tiles, wherein the model input data represents the set of tiles, and wherein each tile of the set of tiles has a corresponding size that is based on a size criterion associated with an image encoding and mapping model.

Example 23 includes the method of Example 22, and further includes determining, based on the boundaries, whether the ROI extends across multiple tiles of the set of tiles, wherein the model input data is modified based on the ROI extending across the multiple tiles.

Example 24 includes the method of Example 23, and further includes, based on the ROI extending across the multiple tiles: modifying a size of a first tile of the multiple tiles such that, after modification of the size, the first tile includes an entirety of the ROI; and for each tile of one or more other tiles included in the multiple tiles, modifying a size of the tile such that the ROI is not included in the tile.

Example 25 includes the method of any of Examples 19 to 24, wherein, prior to modification of the model input data, the model input data represents the image and a query associated with the image.

Example 26 includes the method of Example 25, and further includes determining whether the boundaries satisfy one or more thresholds, wherein, after modification of the model input data, the model input data further represents the ROI based on the boundaries satisfying the one or more thresholds.

Example 27 includes the method of Example 26, and further includes: determining whether the boundaries satisfy a first threshold of the one or more thresholds; determining, based on the boundaries satisfying the first threshold, a patch within the image that includes the ROI; and performing one or more upscaling operations to increase a size of the patch based on a size criterion of an image encoding and mapping model, wherein the one or more upscaling operations preserve an aspect ratio of the patch, and wherein the model input data represents the patch after performance of the one or more upscaling operations.

Example 28 includes the method of Example 26, and further includes: determining whether the boundaries satisfy a second threshold of the one or more thresholds; and determining, based on the boundaries satisfying the second threshold, a patch within the image that includes the ROI, wherein the model input data represents the patch.

Example 29 includes the method of Example 26, and further includes: determining whether the boundaries satisfy a third threshold of the one or more thresholds; performing, based on the boundaries satisfying the third threshold, one or more downscaling operations to decrease a size of the image based on a size criterion of an image encoding and mapping model; and determining a patch within the image that includes the ROI, wherein the model input data represents the patch after performance of the one or more downscaling operations.

Example 30 includes the method of any of Examples 19 to 29, and further includes obtaining one or more hyperparameter values of the trained multimodal model, wherein the one or more hyperparameter values are indicative of a relative weighting of features associated with the ROI relative to features of the image for areas outside the ROI.

Example 31 includes the method of any of Examples 19 to 30, wherein: the trained multimodal model includes an image encoding and mapping model, a text encoding model, and a language model; the image encoding and mapping model is configured to generate first feature data based on the model input data; the text encoding model is configured to generate second feature data based on the model input data; and the language model is configured to generate the response output based on the first feature data and the second feature data.

According to Example 32, a non-transitory computer readable storage medium that stores instructions that, when executed by one or more processors, cause the one or more processors to: obtain image data representing an image; obtain data representing a region of interest (ROI) within the image; determine boundaries of the ROI within the image based on the data; generate model input data based on the image data and the data; selectively modify the model input data based on the boundaries; and provide the model input data as input to a trained multimodal model to generate a response output.

Example 33 includes the non-transitory computer readable storage medium of Example 32, wherein selectively modifying the model input data includes: determining whether the boundaries satisfy one or more thresholds; and modifying the model input data prior to providing the model input data as the input to the trained multimodal model based on the boundaries satisfying the one or more thresholds.

Example 34 includes the non-transitory computer readable storage medium of Example 32, wherein selectively modifying the model input data includes: determining whether the boundaries satisfy one or more thresholds; and providing the model input data as the input to the trained multimodal model without modification based on the boundaries failing to satisfy the one or more thresholds.

Example 35 includes the non-transitory computer readable storage medium of any of Examples 32 to 34, wherein the instructions, when executed by the one or more processors, cause the one or more processors to divide the image into a set of tiles, wherein the model input data represents the set of tiles, and wherein each tile of the set of tiles has a corresponding size that is based on a size criterion associated with an image encoding and mapping model.

Example 36 includes the non-transitory computer readable storage medium of Example 35, wherein the instructions, when executed by the one or more processors, cause the one or more processors to determine, based on the boundaries, whether the ROI extends across multiple tiles of the set of tiles, and wherein the model input data is modified based on the ROI extending across the multiple tiles.

Example 37 includes the non-transitory computer readable storage medium of Example 36, wherein the instructions, when executed by the one or more processors, cause the one or more processors to, based on the ROI extending across the multiple tiles: modify a size of a first tile of the multiple tiles such that, after modification of the size, the first tile includes an entirety of the ROI; and for each tile of one or more other tiles included in the multiple tiles, modify a size of the tile such that the ROI is not included in the tile.

Example 38 includes the non-transitory computer readable storage medium of any of Examples 32 to 37, wherein, prior to modification of the model input data, the model input data represents the image and a query associated with the image.

Example 39 includes the non-transitory computer readable storage medium of Example 38, wherein the instructions, when executed by the one or more processors, cause the one or more processors to determine whether the boundaries satisfy one or more thresholds, and wherein, after modification of the model input data, the model input data further represents the ROI based on the boundaries satisfying the one or more thresholds.

Example 40 includes the non-transitory computer readable storage medium of Example 39, wherein the instructions, when executed by the one or more processors, cause the one or more processors to: determine whether the boundaries satisfy a first threshold of the one or more thresholds; determine, based on the boundaries satisfying the first threshold, a patch within the image that includes the ROI; and perform one or more upscaling operations to increase a size of the patch based on a size criterion of an image encoding and mapping model, wherein the one or more upscaling operations preserve an aspect ratio of the patch, and wherein the model input data represents the patch after performance of the one or more upscaling operations.

Example 41 includes the non-transitory computer readable storage medium of Example 39, wherein the instructions, when executed by the one or more processors, cause the one or more processors to: determine whether the boundaries satisfy a second threshold of the one or more thresholds; and determine, based on the boundaries satisfying the second threshold, a patch within the image that includes the ROI, wherein the model input data represents the patch.

Example 42 includes the non-transitory computer readable storage medium of Example 39, wherein the instructions, when executed by the one or more processors, cause the one or more processors to: determine whether the boundaries satisfy a third threshold of the one or more thresholds; performing, based on the boundaries satisfying the third threshold, one or more downscaling operations to decrease a size of the image based on a size criterion of an image encoding and mapping model; and determining a patch within the image that includes the ROI, wherein the model input data represents the patch after performance of the one or more downscaling operations.

Example 43 includes the non-transitory computer readable storage medium of any of Examples 32 to 42, wherein the instructions, when executed by the one or more processors, cause the one or more processors to obtain one or more hyperparameter values of the trained multimodal model, wherein the one or more hyperparameter values are indicative of a relative weighting of features associated with the ROI relative to features of the image for areas outside the ROI.

Example 44 includes the non-transitory computer readable storage medium of any of Examples 32 to 43, wherein: the trained multimodal model includes an image encoding and mapping model, a text encoding model, and a language model; the image encoding and mapping model is configured to generate first feature data based on the model input data; the text encoding model is configured to generate second feature data based on the model input data; and the language model is configured to generate the response output based on the first feature data and the second feature data.

According to Example 45, an apparatus includes: means for obtaining image data representing an image; means for obtaining data representing a region of interest (ROI) within the image; means for determining boundaries of the ROI within the image based on the data; means for generating model input data based on the image data and the data; means for selectively modifying the model input data based on the boundaries; and means for providing the model input data as input to a trained multimodal model to generate a response output.

Example 46 includes the apparatus of Example 45, wherein the means for selectively modifying the model input data includes: means for determining whether the boundaries satisfy one or more thresholds; and means for modifying the model input data prior to providing the model input data as the input to the trained multimodal model based on the boundaries satisfying the one or more thresholds.

Example 47 includes the apparatus of Example 45, wherein the means for selectively modifying the model input data includes: means for determining whether the boundaries satisfy one or more thresholds; and means for providing the model input data as the input to the trained multimodal model without modification based on the boundaries failing to satisfy the one or more thresholds.

Example 48 includes the apparatus of any of Examples 45 to 47, and further includes means for dividing the image into a set of tiles, wherein the model input data represents the set of tiles, and wherein each tile of the set of tiles has a corresponding size that is based on a size criterion associated with an image encoding and mapping model.

Example 49 includes the apparatus of Example 48, and further includes means for determining, based on the boundaries, whether the ROI extends across multiple tiles of the set of tiles, wherein the model input data is modified based on the ROI extending across the multiple tiles.

Example 50 includes the apparatus of Example 49, and further includes: means for modifying, based on the ROI extending across the multiple tiles, a size of a first tile of the multiple tiles such that, after modification of the size, the first tile includes an entirety of the ROI; and means for modifying, for each tile of one or more other tiles included in the multiple tiles, a size of the tile such that the ROI is not included in the tile.

Example 51 includes the apparatus of any of Examples 45 to 50, wherein, prior to modification of the model input data, the model input data represents the image and a query associated with the image.

Example 52 includes the apparatus of Example 51, and further includes means for determining whether the boundaries satisfy one or more thresholds, wherein, after modification of the model input data, the model input data further represents the ROI based on the boundaries satisfying the one or more thresholds.

Example 53 includes the apparatus of Example 52, and further includes: means for determining whether the boundaries satisfy a first threshold of the one or more thresholds; means for determining, based on the boundaries satisfying the first threshold, a patch within the image that includes the ROI; and means for performing one or more upscaling operations to increase a size of the patch based on a size criterion of an image encoding and mapping model, wherein the one or more upscaling operations preserve an aspect ratio of the patch, and wherein the model input data represents the patch after performance of the one or more upscaling operations.

Example 54 includes the apparatus of Example 52, and further includes: means for determining whether the boundaries satisfy a second threshold of the one or more thresholds; and means for determining, based on the boundaries satisfying the second threshold, a patch within the image that includes the ROI, wherein the model input data represents the patch.

Example 55 includes the apparatus of Example 52, and further includes: means for determining whether the boundaries satisfy a third threshold of the one or more thresholds; means for performing, based on the boundaries satisfying the third threshold, one or more downscaling operations to decrease a size of the image based on a size criterion of an image encoding and mapping model; and means for determining a patch within the image that includes the ROI, wherein the model input data represents the patch after performance of the one or more downscaling operations.

Example 56 includes the apparatus of any of Examples 45 to 55, and further includes means for obtaining one or more hyperparameter values of the trained multimodal model, wherein the one or more hyperparameter values are indicative of a relative weighting of features associated with the ROI relative to features of the image for areas outside the ROI.

Example 57 includes the apparatus of any of Examples 45 to 56, wherein: the trained multimodal model includes an image encoding and mapping model, a text encoding model, and a language model; the image encoding and mapping model is configured to generate first feature data based on the model input data; the text encoding model is configured to generate second feature data based on the model input data; and the language model is configured to generate the response output based on the first feature data and the second feature data.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store model data associated with a trained multimodal model; and
one or more processors coupled to the memory, wherein the one or more processors are configured to:
obtain image data representing an image;
obtain data representing a region of interest (ROI) within the image;
determine boundaries of the ROI within the image based on the data;
generate model input data based on the image data and the data;
selectively modify the model input data based on the boundaries; and
provide the model input data as input to the trained multimodal model to generate a response output.

2. The device of claim 1, wherein the one or more processors are configured to:
divide the image into a set of tiles, wherein the model input data represents the set of tiles, and wherein each tile of the set of tiles has a corresponding size that is based on a size criterion associated with an image encoding and mapping model.

3. The device of claim 2, wherein the one or more processors are configured to:
determine, based on the boundaries, whether the ROI extends across multiple tiles of the set of tiles, wherein the model input data is modified based on the ROI extending across the multiple tiles.

4. The device of claim 3, wherein the one or more processors are configured to, based on the ROI extending across the multiple tiles:
modify a size of a first tile of the multiple tiles such that, after modification of the size, the first tile includes an entirety of the ROI; and
for each tile of one or more other tiles included in the multiple tiles, modify a size of the tile such that the ROI is not included in the tile.

5. The device of claim 1, wherein, prior to modification of the model input data, the model input data represents the image and a query associated with the image.

6. The device of claim 5, wherein the one or more processors are configured to:
determine whether the boundaries satisfy one or more thresholds, wherein, after modification of the model input data, the model input data further represents the ROI based on the boundaries satisfying the one or more thresholds.

7. The device of claim 6, wherein the one or more processors are configured to:
determine whether the boundaries satisfy a first threshold of the one or more thresholds;
determine, based on the boundaries satisfying the first threshold, a patch within the image that includes the ROI; and
perform one or more upscaling operations to increase a size of the patch based on a size criterion of an image encoding and mapping model, wherein the one or more upscaling operations preserve an aspect ratio of the patch, and wherein the model input data represents the patch after performance of the one or more upscaling operations.

8. The device of claim 6, wherein the one or more processors are configured to:
determine whether the boundaries satisfy a second threshold of the one or more thresholds; and
determine, based on the boundaries satisfying the second threshold, a patch within the image that includes the ROI, wherein the model input data represents the patch.

9. The device of claim 6, wherein the one or more processors are configured to:
determine whether the boundaries satisfy a third threshold of the one or more thresholds;
perform, based on the boundaries satisfying the third threshold, one or more downscaling operations to decrease a size of the image based on a size criterion of an image encoding and mapping model; and
determine a patch within the image that includes the ROI, wherein the model input data represents the patch after performance of the one or more downscaling operations.

10. The device of claim 1, wherein the one or more processors are configured to:
obtain one or more hyperparameter values of the trained multimodal model, wherein the one or more hyperparameter values are indicative of a relative weighting of features associated with the ROI relative to features of the image for areas outside the ROI.

11. The device of claim 1, wherein:
the trained multimodal model includes an image encoding and mapping model, a text encoding model, and a language model;
the image encoding and mapping model is configured to generate first feature data based on the model input data;
the text encoding model is configured to generate second feature data based on the model input data; and
the language model is configured to generate the response output based on the first feature data and the second feature data.

12. The device of claim 1, further comprising a modem coupled to the one or more processors and configured to receive the image data, the data representing the ROI, or a combination thereof.

13. The device of claim 1, further comprising one or more cameras coupled to the one or more processors and configured to generate the image data.

14. The device of claim 1, further comprising one or more microphones configured to generate audio data representing user speech, wherein the data representing the ROI includes the audio data.

15. The device of claim 1, further comprising a user interface configured to generate text data based on user input, wherein the data representing the ROI includes the text data.

16. The device of claim 1, wherein the one or more processors are included in an integrated circuit.

17. The device of claim 1, wherein the one or more processors are integrated in at least one of a mobile phone, a tablet computer device, a wearable electronic device, an extended reality (XR) device, or a camera device, and wherein the mobile phone, the tablet computer device, the wearable electronic device, the XR device, or the camera device is configured to output the response output.

18. The device of claim 1, wherein the one or more processors are integrated in a vehicle that is configured to output the response output.

19. A method comprising:
obtaining, by one or more processors, image data representing an image;
obtaining, by the one or more processors, data representing a region of interest (ROI) within the image;
determining, by the one or more processors, boundaries of the ROI within the image based on the data;
generating, by the one or more processors, model input data based on the image data and the data;
selectively modifying, by the one or more processors, the model input data based on the boundaries; and
providing, by the one or more processors, the model input data as input to a trained multimodal model to generate a response output.

20. A non-transitory computer readable storage medium that stores instructions that, when executed by one or more processors, cause the one or more processors to:
obtain image data representing an image;
obtain data representing a region of interest (ROI) within the image;
determine boundaries of the ROI within the image based on the data;
generate model input data based on the image data and the data;
selectively modify the model input data based on the boundaries; and
provide the model input data as input to a trained multimodal model to generate a response output.
